(19) United States
(12) Patent Application Publication
(10) Pub. No.: US 2025/0074738 A1
(43) Pub. Date: Mar. 6, 2025

(54) SHEET PROCESSING APPARATUS AND IMAGE FORMING SYSTEM

(71) Applicant: CANON FINETECH NISCA INC., Saitama (JP)

(72) Inventors: Shoubu Kato, Yamanashi (JP); Shinnosuke Enomoto, Yamanashi (JP); Hiroki Komada, Yamanashi (JP); Akito Yoda, Yamanashi (JP); Taiki Akiyama, Yamanashi (JP)

(21) Appl. No.: 18/810,646

(22) Filed: Aug. 21, 2024

(30) Foreign Application Priority Data
Aug. 30, 2023 (JP) 2023-140510

(51) Int. Cl. B65H 37/04; B65H 31/34

(52) U.S. Cl. CPC B65H 37/04; B65H 31/34; B65H 2301/4226; B65H 2404/74; B65H 2701/13212; B65H 2701/1822; B65H 2801/27

(57) ABSTRACT

A square back processing unit performs a square back process on the sheet bundle and includes a pair of clamp portions. The sheet bundle subjected to the square back process by the square back processing unit is discharged to a sheet bundle discharge unit. A cover unit is provided downstream of the square back processing unit in the conveyance direction such that a child access probe according to a safety standard IEC 62368-1 does not reach the pair of clamp portions in a case where the child access probe is inserted from an outside of the sheet processing apparatus.

### BACKGROUND OF THE INVENTION

### Field of the Invention

The present invention relates to a sheet processing apparatus that performs a square back process on sheets and an image forming system including the sheet processing apparatus.

### Description of the Related Art

As a sheet processing apparatus, a configuration in which a process (hereinafter referred to as a square back process) of forming a corner on a spine of a folded sheet bundle is performed by pressing the spine portion of the sheet bundle protruding from a pair of clamp portions in a state in which the sheet bundle is clamped by the clamp portions is proposed (Japanese Patent Application Laid-Open No. 2001-260564). In addition, as a sheet processing apparatus, a configuration in which a saddle binding process of performing a binding process on a center portion of a sheet bundle in a conveyance direction and a half-folding process of folding the sheet bundle at a position where the saddle binding process is performed are performed is proposed (Japanese Patent Application Laid-Open No. 2018-150096).

Here, in the case where the configuration of performing the square back process disclosed in Japanese Patent Application Laid-Open No. 2001-260564 is provided in the sheet processing apparatus disclosed in Japanese Patent Application Laid-Open No. 2018-150096, it is required that a safety standard IEC 62368-1 is satisfied. In this safety standard, an access check to a dangerous part using a “child access probe” needs to be passed. In contrast, in the apparatus that performs a square back process disclosed in Japanese Patent Application Laid-Open No. 2001-260564, since a sheet bundle obtained by performing the square back process on the folded sheet bundle is discharged, an opening of a sufficient size is required as a discharge port for discharging this sheet bundle. In the square back process, the sheet bundle is clamped by a pair of clamp portions, but if the opening of the discharge port for the sheet bundle is large, there is a possibility that the “child access probe” can access the pair of clamp portions.

### SUMMARY OF THE INVENTION

An object of the present invention is to provide a configuration of a sheet processing apparatus including an element for performing a square back process that can easily satisfy the safety standards.

According to one aspect of the present invention, a sheet processing apparatus includes an inlet portion configured to receive a sheet discharged from an image forming apparatus, a first accumulation portion configured to accumulate the sheet received from the inlet portion, a first binding processing unit configured to perform a binding process on an end portion of a sheet bundle constituted by a plurality of sheets accumulated in the first accumulation portion, a stacking unit that is capable of moving up and down with respect to the first accumulation portion and on which the sheet bundle subjected to the binding process by the first binding processing unit is stacked, a conveyance unit configured to convey the sheet downward in an up-down direction from a branching point in a conveyance path from the inlet portion to the first accumulation portion, a second accumulation portion configured accumulate the sheet conveyed by the conveyance unit, a second binding processing unit configured to perform a saddle binding process on a sheet bundle constituted by a plurality of sheets accumulated in the second accumulation portion, a half-folding processing unit including a folding roller pair and a pressing portion and configured to perform a half-folding process on the sheet bundle subjected to the saddle binding process by the second binding process unit, the folding roller pair being configured to nip and convey the sheet bundle such that a spine of the sheet bundle is positioned downstream of a fore edge of the sheet bundle and thus perform half-folding on the sheet bundle, the pressing portion being configured to press the sheet bundle subjected to the saddle binding process by the second binding process unit toward a nip portion of the folding roller pair, a conveyance roller pair configured to nip and convey the sheet bundle subjected to the half-folding process by the half-folding processing unit, a square back processing unit including a pair of clamp portions configured to relatively move with respect to the sheet bundle conveyed by the conveyance roller pair to nip or not nip the sheet bundle, and a pressing roller provided downstream of the pair of clamp portions in a conveyance direction of the sheet bundle by the conveyance roller pair and press the spine of the sheet bundle nipped by the pair of clamp portions toward the pair of clamp portions, the square back processing unit being configured to perform a square back process of forming a corner on the spine of the sheet bundle by pressing, by the pressing roller, the spine of the sheet bundle nipped by the pair of clamp portions such that the spine of the sheet bundle protrudes downstream in the conveyance direction with respect to the pair of clamp portions, a sheet bundle discharge unit to which the sheet bundle subjected to the square back process by the square back processing unit is discharged, and, a cover unit provided downstream of the square back processing unit in the conveyance direction such that a child access probe according to a safety standard IEC 62368-1 does not reach the pair of clamp portions in a case where the child access probe is inserted from an outside of the sheet processing apparatus.

Further features of the present invention will become apparent from the following description of exemplary embodiments with reference to the attached drawings.

### BRIEF DESCRIPTION OF THE DRAWINGS

FIG. 1 is a schematic configurational section view of an image forming system according to an embodiment.

FIG. 2 is a schematic configurational section view of a sheet processing apparatus according to the embodiment.

FIG. 3 is a control block diagram of the image forming system according to the embodiment.

FIG. 4 is an enlarged section view of a saddle portion according to the embodiment.

FIG. 5 is a front view of a square back processing portion according to the embodiment.

FIG. 6A is a perspective view of a square back processing unit according to the embodiment.

FIG. 6B is a section view of the square back processing unit according to the embodiment.

FIG. 7A is a perspective view of the square back processing portion according to the embodiment as viewed from the front side.

FIG. 7B is a perspective view of the square back processing portion according to the embodiment as viewed from the rear side.

FIG. 8 is a perspective view of part of the square back processing unit and a driving portion according to the embodiment.

FIG. 9 is a perspective view of the vicinity of the square back processing unit and a clamp portion according to the embodiment.

FIG. 10 is a section view of the square back processing unit and the clamp portion according to the embodiment.

FIG. 11A is a schematic diagram illustrating a state in which conveyance of a sheet bundle is stopped at the clamp portion in an operation of the square back process in the embodiment.

FIG. 11B is a schematic diagram illustrating a state in which the sheet bundle is clamped in the operation of the square back process in the embodiment.

FIG. 11C is a schematic diagram illustrating a state in which the square back process is performed on the sheet bundle in the operation of the square back process in the embodiment.

FIG. 11D is a schematic diagram illustrating a state in which the clamping of the sheet bundle is released in the operation of the square back process in the embodiment.

FIG. 12 is a perspective view of the vicinity of a sheet bundle discharge portion of the sheet processing apparatus in the embodiment in which a discharge cover is omitted.

FIG. 13 is a perspective view of the vicinity of the sheet bundle discharge portion in the embodiment.

FIG. 14 is a plan view of the vicinity of the sheet bundle discharge portion of the sheet processing apparatus in the embodiment as viewed from the front side in the sheet bundle discharge direction.

FIG. 15A is a perspective view of the vicinity of a movable wall and a discharge cover in the embodiment as viewed from the back side in the sheet bundle discharge direction.

FIG. 15B is an enlarged perspective view of part of FIG. 15A.

FIG. 16 is a schematic configurational section view of the sheet processing apparatus illustrating a state in which the discharge cover according to the embodiment is open.

FIG. 17 is a schematic configurational section view of the sheet processing apparatus illustrating a state in which a first tray according to the embodiment has been lowered to a position below a predetermined position.

FIG. 18 is a perspective view of the vicinity of the sheet bundle discharge portion of the sheet processing apparatus in the embodiment in a state in which the discharge cover is closed.

FIG. 19 is a perspective view of the vicinity of the sheet bundle discharge portion of the sheet processing apparatus in the embodiment in a state in which the discharge cover is open.

FIG. 20 is a section view of the vicinity of the sheet bundle discharge portion illustrating a state in which a child access probe is inserted through a saddle discharge port in the sheet processing apparatus in the embodiment.

FIG. 21 is a section view of the vicinity of the sheet bundle discharge portion illustrating another example of a configuration for guiding the opening and closing of the discharge cover according to the embodiment.

### DESCRIPTION OF THE EMBODIMENTS

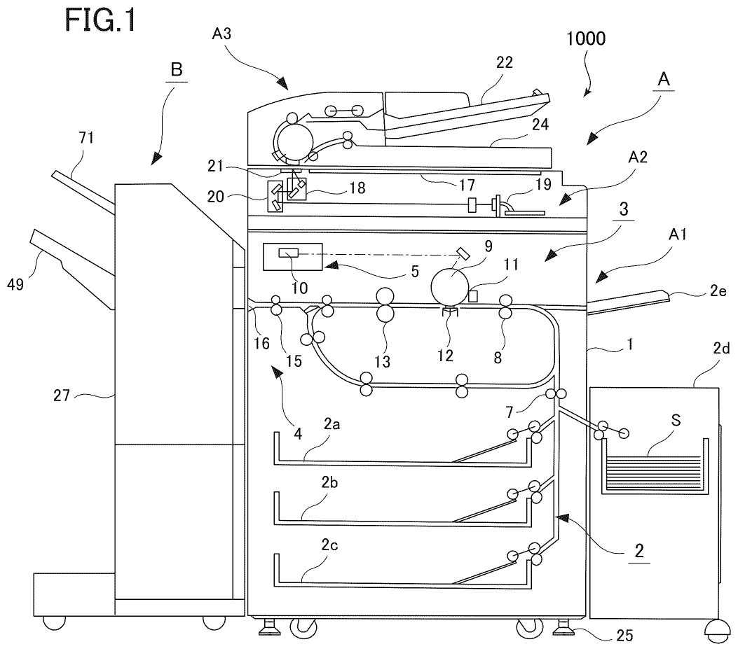

An embodiment will be described with reference to FIGS. 1 to 21. First, a schematic configuration of an image forming system of the present embodiment will be described with reference to FIG. 1.

### Image Forming System

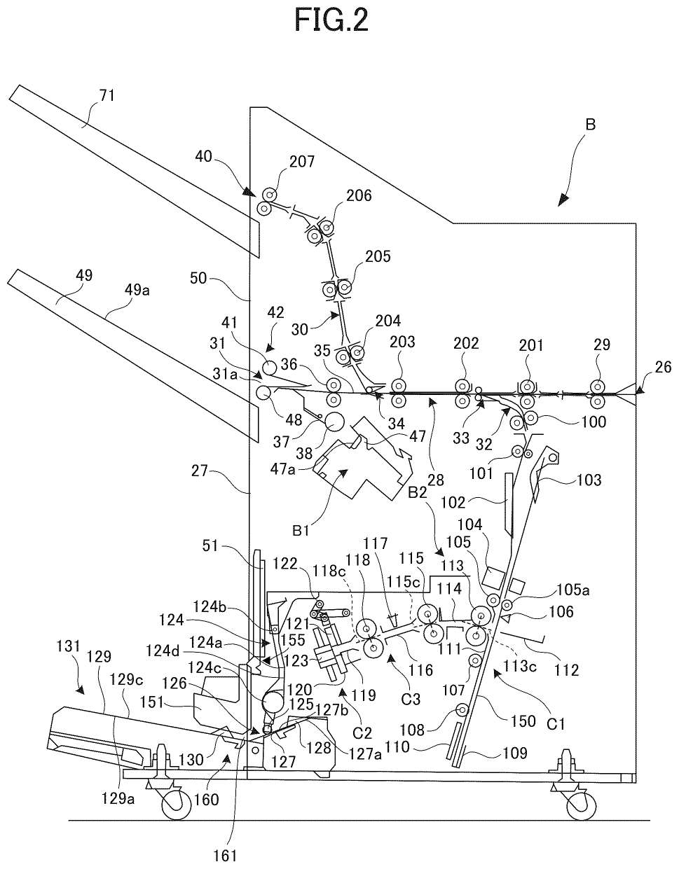

In the present embodiment, a copier is used as the image forming apparatus. A sheet processing apparatus is connected to a sheet discharge port of this copier, and the sheet processing apparatus includes a saddle portion that performs a saddle binding process and a half-folding process. The image forming system 1000 includes an image forming apparatus A and a sheet processing apparatus B. A sheet S on which an image has been formed by the image forming apparatus A is received by the sheet processing apparatus B provided on the downstream side, is subjected to the saddle binding process, the half-folding process, the square back process, and the like if necessary, and is discharged to a discharge portion provided on the downstream side. Examples of the image forming apparatus A include apparatuses of various structures such as copiers, printer, printing machines, facsimile machines, and multifunctional apparatuses having a plurality of functions of these. The image forming apparatus A and the sheet processing apparatus B will be described in detail below. To be noted, in the description below, regarding the image forming apparatus A and the sheet processing apparatus B, the side on which an operator such as a user operates the apparatus (for example, the side on which an operation panel, an operation button, and the like are provided) will be referred to as the front side (front side of the paper surface in FIGS. 1, 2, and the like), and the side opposite to the front side will be referred to as the rear side (rear side of the paper surface in FIGS. 1, 2, and the like).

### Image Forming Apparatus

As illustrated in FIG. 1, the image forming apparatus A includes an image forming unit A1, an image reading unit A2, and a document feeding unit A3. The image forming unit A1 includes, in a housing 1, a feeding portion 2, an image forming portion 3, a discharge portion 4, and a data processing portion 5.

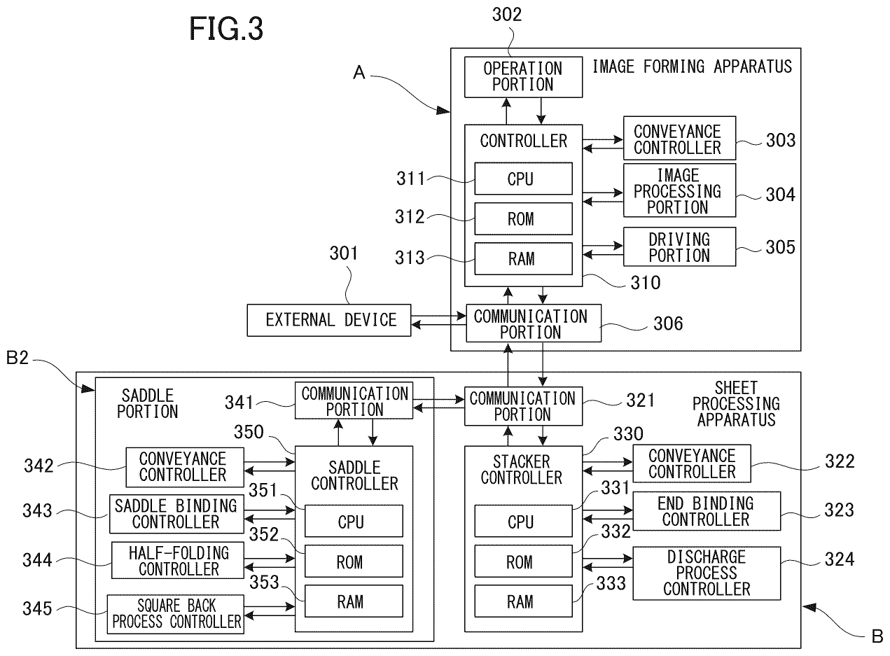

The feeding portion 2 includes a plurality of cassettes 2a, 2b, and 2c, and in the cassettes 2a, 2b, and 2c are capable of accommodating, in a plurality of tiers, sheets S of different regular sizes that are selected in advance. The sheet S is, for example, a paper sheet, a plastic sheet, or the like. The cassettes 2a, 2b, and 2c each include a separation mechanism that separates the sheets S stored therein from each other, and a feeding mechanism that delivers out the sheet S. Regarding the sheet S accommodated in the feeding portion 2 configured in this manner, the sheet S of a size designated by a controller 310 (FIG. 3) of the image forming apparatus A is delivered out. The sheet S fed from one of the plurality of cassettes 2a, 2b, and 2c is conveyed further downstream by a conveyance roller 7. The leading end of the sheet S conveyed by the conveyance roller 7 is aligned by a registration roller pair 8, and thus the skew thereof is corrected. Then, the sheet S whose leading end is aligned by the registration roller pair 8 is fed to the image forming portion 3 provided on the downstream side at a predetermined timing.

A large capacity cassette 2d and a manual feed tray 2e are coupled to the image forming apparatus A. The large capacity cassette 2d is constituted by an optional unit that accommodates sheets of a size that is to be consumed by a large amount. The manual feed tray 2e is configured to be capable of supplying special sheets such as cardboard sheets, coated sheets, and film sheets that are difficult to convey while separating the sheets from each other.

It suffices as long as the image forming portion 3 is configured to form an image on the sheet S fed from the feeding portion 2, and various image forming mechanisms can be employed. In the illustrated embodiment, an electrostatic image forming mechanism is illustrated as the image forming portion 3. However, the image forming portion 3 is not limited to the electrostatic image forming mechanism that is illustrated, and an ink jet image forming mechanism, an offset image forming mechanism, and the like can be also employed.

The image forming portion 3 illustrated in FIG. 1 is provided with a photosensitive member 9 formed in a drum shape or a belt shape, an exposing unit 10 that exposes the photosensitive member 9, a developing unit 11 that develops an electrostatic latent image on the photosensitive member 9 by using toner, and a cleaner (not illustrated) that cleans an unillustrated charging unit that charges the photosensitive member 9, the photosensitive member 9, and the like. In FIG. 1, a monochromatic printing mechanism is illustrated as an example. An electrostatic latent image is formed on the photosensitive member 9 by exposure by the exposing unit 10 and is developed by the developing unit 11, and thus a toner image is formed on the photosensitive member 9. The toner image formed on the photosensitive member 9 is, by a transfer unit 12, transferred onto the sheet S conveyed from the registration roller pair 8. The sheet S onto which a toner image has been transferred is fixed by the fixing unit 13. In addition, the image forming apparatus A is provided with a reverse conveyance path, the sheet S to which the toner image has been fixed by a fixing unit 13 is inverted such that the front surface and the back surface thereof are switched and is then conveyed to the registration roller pair 8 again, and image formation is performed on the back surface of the sheet S. A discharge roller 15 is provided downstream of the fixing unit 13 and downstream of a branching point to the reverse conveyance path, and conveys the sheet S from a discharge port 16 of the image forming apparatus A to the sheet processing apparatus B that will be described later.

An image reading unit A2 that optically reads a document image is provided above the image forming unit A1 configured in this manner, and a document feeding unit A3 is further provided above the image reading unit A2.

The image reading unit A2 includes a first platen glass 17, a second platen glass 21, a reading carriage 18 including a light source, a photoelectric conversion element 19, and a reduction optical system 20 constituted by combining mirrors and lenses. Further, the reading carriage 18 is moved in a scanning manner along the first platen glass 17 to irradiate an image of a document placed on the first platen glass 17 with light from the light source, and reflection light from the image of the document is guided to the photoelectric conversion element 19 through the reduction optical system 20 to read the image. The photoelectric conversion element 19 converts image data into an electric signal and transfers the electric signal to the image forming portion 3, and thus the image read by the image reading unit A2 can be formed on a sheet by the image forming unit A1.

The document feeding unit A3 includes a feeding tray 22 and a discharge tray 24, conveys documents placed on the feeding tray 22 one by one through a space on the second platen glass 21, and discharges the document onto the discharge tray 24. To be noted, when reading the document fed by the document feeding unit A3 and passing through the space on the second platen glass 21, the reading carriage 18 is stopped at a position below the second platen glass 21 in advance, and image data is read from an image passing through the space on the second platen glass 21.

### Overall Configuration of Sheet Processing Apparatus

Next, an overall configuration of the sheet processing apparatus B that performs a process such as a stapling process, a folding process, and the like on sheets conveyed from the image forming apparatus A will be described next with reference to FIG. 2. FIG. 2 illustrates a detailed configuration of the sheet processing apparatus B. The sheet processing apparatus B is capable of stacking sheets on a first tray (first stacking tray) 49, a saddle discharge unit 131, and a second tray (second stacking tray) 71 that will be described later after processing the sheets received through an inlet portion 26 serving as an inlet of a conveyance path 28 continuous from the discharge port 16. To be noted, in the present embodiment, a path refers to the entirety of a path in which a sheet is conveyed by a conveyance guide, a conveyance roller, and the like.

In the illustrated apparatus, the sheet conveyed to the conveyance path 28 serving as a first conveyance path is discharged onto a first tray 49 after being processed by a processing portion B1 that will be described later, or the sheet conveyed in the conveyance path 28 is discharged onto the second tray 71, or is discharged to a saddle discharge unit 131 after being processed by a saddle portion B2 that will be described later. Each apparatus includes a controller, a communication portion, and the like as indicated by blocks representing the overall control configuration of the apparatus illustrated in FIG. 3, and thus the apparatus is controlled.

The processing portion B1 serving as an end binding processing portion is disposed below a path outlet (passing portion 35) of the conveyance path 28, and is capable of accumulating a plurality of sheets sequentially passed on thereto from the conveyance path 28 through the passing portion 35 for each copy to form a sheet bundle, and executing a binding process that is an example of a predetermined process on an end portion of the sheet bundle. The sheet bundle subjected to the binding process is stacked on the first tray 49 serving as a stacking portion (stacking unit). The trailing end (a sheet end portion on the upstream side in the discharge direction, upstream end) of the sheet or sheet bundle stacked on the first tray 49 abuts a stacking wall 50 provided on the upstream side in the sheet discharge direction of the first tray 49, and is thus stacked along the stacking wall 50. The stacking wall 50 is a wall portion extending in a direction in which the first tray 49 moves up and down.

The first tray 49 is capable of moving up and down with respect to a processing tray 37 that will be described later, and supports thereon a sheet bundle subjected to the binding process by a binding processing mechanism 47 that will be described later. In the present embodiment, the first tray 49 and the second tray 71 are capable of moving up and down by an unillustrated lifting/lowering mechanism. That is, in the present embodiment, when delivering out the sheet onto the first tray 49 or the second tray 71 serving as a stacking tray, the first tray 49 or the second tray 71 is moved up or down to maintain the position of the uppermost sheet on the stacking surface of the tray constant with respect to the discharge roller pair 42 and a second discharge roller 207 such that the alignment of the stacked sheets is not degraded.

The saddle portion B2 is disposed below the passing portion of the saddle path 32 serving as a second conveyance path branching downward in the vertical direction from the conveyance path 28, accumulates a plurality of sheets sequentially passed on thereto from the conveyance path 28 through the saddle path 32 and the passing portion for each copy to form a sheet bundle, performs a folding process after executing a saddle binding process or without performing the saddle binding process, and discharges the sheet bundle to the saddle discharge unit 131. Detailed description of each configuration will be given below.

### Housing

As illustrated in FIG. 2, the sheet processing apparatus B includes a housing 27, the conveyance path 28, the processing portion B1, the saddle portion B2, the first tray 49, the saddle discharge unit 131, the second tray 71, and the like. The conveyance path 28, the processing portion B1, and the saddle portion B2 are disposed inside the housing 27. In addition, the conveyance path 28 includes the inlet portion 26 and the passing portion 35 for the sheet. The processing portion B1 and the saddle portion B2 process the sheet passed on thereto from the passing portion 35 of the conveyance path 28. The first tray 49, the saddle discharge unit 131, and the second tray 71 support thereon a sheet conveyed from each processing portion. The illustrated housing 27 is connected to a housing 1 of the image forming apparatus A positioned upstream thereof in the sheet conveyance direction in the conveyance path 28. Further, the housing 27 and the housing 1 are disposed such that the height of the discharge port 16 of the image forming apparatus A from the installation surface and the height of the inlet portion 26 of the sheet processing apparatus B from the installation surface are approximately equal, and the discharge port 16 and the inlet portion 26 are connected.

### Sheet Introduction Path

The conveyance path 28 serving as a sheet introduction path is configured as an approximately linear path traversing the housing 27 in an approximately horizontal direction, and includes the inlet portion 26 continuous with the discharge port (body discharge port) 16 of the image forming apparatus A and the passing portion 35 positioned on the opposite side across the apparatus with respect to the inlet portion 26. In the conveyance path 28, an inlet roller 29, a first conveyance roller 201, a second conveyance roller 202, and a third conveyance roller 203 serving as conveyance rollers capable of conveying the sheet in a first direction from the inlet portion 26 toward a first discharge path 31 and capable of conveying the sheet in a second direction from the first discharge path 31 toward the inlet portion 26. That is, the inlet roller 29, the first conveyance roller 201, the second conveyance roller 202, and the third conveyance roller 203 are capable of conveying the sheet in the first direction and the second direction opposite to the first direction in the conveyance path, and are arranged in this order from the inlet portion 26 side in the first direction.

The first discharge path 31 is connected to the passing portion 35 of the conveyance path 28, and the first conveyance roller 36 is disposed at a connecting portion of these. The sheet passed on from the conveyance path 28 to the first discharge path 31 and discharged from the first discharge path 31 is stacked on the first tray 49 or guided to the processing portion B1. To be noted, each conveyance roller described above may be a different member capable of conveying a sheet such as a conveyance belt.

### Layout of Sheet Introduction Path

The saddle path 32 and the upper conveyance path 30 that are branch paths are connected to the conveyance path 28 as illustrated in FIG. 2. The saddle path 32 and the upper conveyance path 30 are arranged in this order from the inlet portion 26 toward the first discharge path 31 in the first direction. In addition, the saddle path 32 branches downward from the conveyance path 28 in the vertical direction, and the upper conveyance path 30 branches upward from the conveyance path 28 in the vertical direction. A saddle path switching member 33 and an upper conveyance path switching member 34 serving as switching members that switch the conveyance direction of the conveyed sheet are respectively disposed at the respective branching portions between the conveyance path 28 and the saddle path 32 and between the conveyance path 28 and the upper conveyance path 30.

### Branching Portion of Path

The upper conveyance path switching member 34 is constituted by a switching guide capable of moving to change the conveyance path of the sheet introduced from the inlet portion 26 to convey the sheet to the first discharge path 31 or the upper conveyance path 30, and is moved by a driving portion (not illustrated) such as an electromagnetic solenoid or a mini motor.

### Upper Conveyance Path

The upper conveyance path 30 (print-out discharge path) in which a sheet other than a sheet to be discharged to the first discharge path 31 is conveyed branches from the conveyance path 28, and the upper conveyance path switching member 34 for guiding the sheet to the upper conveyance path 30 is provided at the path branching portion thereof. In addition, in the upper conveyance path 30, a fourth conveyance roller 204, a fifth conveyance roller 205, a sixth conveyance roller 206, and a second discharge roller 207 are provided in the upper conveyance path 30 as conveyance rollers that guide the sheet to the second tray 71. As a result of this, the sheet guided to the upper conveyance path 30 is discharged onto the second tray 71 (overflow tray) from an upper conveyance path discharge port 40.

The processing portion B1 is constituted by a processing tray 37 serving as a placement portion and a first accumulation portion that places thereon a sheet conveyed through the first discharge path 31 provided downstream of the conveyance path 28 and accumulates a plurality of placed sheets for each copy, and a binding processing mechanism (end binding stapling unit) 47 serving as a first binding processing portion (first binding processing unit) that performs a binding process on the accumulated sheet bundle. Further, the processing portion B1 performs a binding process on the sheet bundle placed on the processing tray 37. The binding processing mechanism 47 is disposed below the conveyance path 28 in the vertical direction. As illustrated in FIG. 2, a step is formed in the first discharge path 31, and the processing tray 37 is disposed below the step. A first switchback path in which the sheet is guided onto the processing tray 37 after reversing the conveyance direction in a state in which part of the sheet has been discharged onto the first tray 49 through the discharge port 31a of the first discharge path 31 is provided between the first discharge path 31 and the processing tray 37.

Specifically, in the first discharge path 31, an upper conveyance roller 41 and a lower conveyance roller 48 that nip and convey the sheet are provided. The upper conveyance roller 41 and the lower conveyance roller 48 constitute a discharge roller pair 42 serving as a discharge portion (discharge unit). The upper conveyance roller 41 is capable of coming into and out of contact with and from the lower conveyance roller 48, and the sheet can be conveyed in a direction toward the first tray 49 and a direction opposite to this direction in a state in which the sheet is nipped between the upper conveyance roller 41 and the lower conveyance roller 48. Further, the sheet can be conveyed toward the processing tray 37 through the first switchback path by the upper conveyance roller 41 and the lower conveyance roller 48.

In addition, the upper conveyance roller 41 and the lower conveyance roller 48 (that is, the discharge roller pair 42) discharge the sheet or sheet bundle on the processing tray 37 onto the first tray 49 serving as a stacking tray (stacking portion) through the discharge port 31a. The discharge port 31a is a portion opening at a position above the lower conveyance roller 48 in the housing 27. Further, the discharge roller pair 42 discharges the sheet conveyed to the first discharge path 31 without passing the processing tray 37 onto the first tray 49 through the discharge port 31a.

The binding processing mechanism 47 includes a trailing end regulating portion 47a that abuts an end portion (trailing end) of the sheet and positions the sheet. A reversing portion 38 that conveys the sheet conveyed to the processing tray 37 by the upper conveyance roller 41 and the lower conveyance roller 48 toward the trailing end regulating portion 47a is disposed on the processing tray 37. Further, the binding processing mechanism 47 performs a binding process on an end portion of a sheet bundle constituted by a plurality of sheets which are placed on the processing tray 37 and a position of an end portion of which is regulated by the trailing end regulating portion 47a. In addition, the binding processing mechanism 47 includes a sheet bundle discharge mechanism that discharges the sheet bundle onto the first tray 49 after performing the binding process on the end portion of the sheet bundle.

To be noted, the binding processing mechanism 47 illustrated in FIG. 2 supports the sheet conveyed from the first discharge path 31 such that the sheet bridges the processing tray 37 and the first tray 49 provided downstream thereof. That is, the sheet conveyed from the first discharge path 31 is supported such that the leading end portion of the sheet is supported on the uppermost sheet on the first tray 49 provided on the downstream side, and the trailing end portion of the sheet is supported on the processing tray 37.

### Saddle Path

The saddle path 32 for conveying the sheet to the saddle portion B2 described above is connected to the conveyance path 28, and the saddle path switching member 33 for guiding the sheet to the saddle path 32 is provided at the path branching portion thereof. The sheet guided to the saddle portion B2 through the saddle path 32 is accumulated on the saddle stacking tray 150, is subjected to the half-folding process, and after being subjected to the folding process, is discharged to the saddle discharge unit 131 via a post-folding path guide 114, a post-second roller path guide 116, a pre-clamp guide 119, and a saddle discharge guide 124. In the present embodiment, the saddle discharge guide 124 serving as a discharge guide portion is used as an auxiliary guide for appropriately stacking the sheet on the saddle discharge unit 131.

### Control Configuration

The outline of a control configuration of the image forming system 1000 will be described with reference to FIG. 3. First, the image forming apparatus A includes a controller 310, an operation portion 302, a conveyance controller 303, an image processing portion 304, a driving portion 305, and a communication portion 306. The controller 310 includes a central processing unit: CPU 311, a read-only memory: ROM 312, and a random access memory: RAM 313. The CPU 311 controls each component while reading out a program corresponding to a control procedure stored in the ROM 312. In addition, the RAM 313 stores work data and input data, and the CPU 311 performs control with reference to data stored in the RAM 313 on the basis of the program described above and the like.

The operation portion 302 is, for example, an operation panel provided in the image forming apparatus A and connected to the controller 310, and an operator operates the apparatus and performs various settings thereby. The conveyance controller 303 controls the various conveyance rollers that convey the sheet and the switching members that switch the conveyance path in the image forming apparatus A. The image processing portion 304 controls the image forming portion 3. The driving portion 305 controls various motors and the power source. The communication portion 306 communicably connects an external device 301 such as a personal computer and a communication portion 321 of the sheet processing apparatus B with the controller 310.

The sheet processing apparatus B includes a stacker controller 330, a conveyance controller 322, an end binding controller 323, a discharge process controller 324, and the communication portion 321. The stacker controller 330 includes a CPU 331, a ROM 332, and a RAM 333 similarly to the controller 310. The conveyance controller 322 controls the various conveyance rollers that convey the sheet and the switching members that switch the conveyance path in part of the sheet processing apparatus B other than the saddle portion B2. The end binding controller 323 controls the processing portion B1. The discharge process controller 324 controls various stacking trays onto which sheets are discharged and on which the discharged sheets are stacked. The communication portion 321 communicably connects the communication portion 306 of the image forming apparatus A and a communication portion 341 of the saddle portion B2 with the stacker controller 330. To be noted, the communication between the communication portion 306 and the communication portion 321 may be performed by wired communication or wireless communication.

The saddle portion B2 includes a saddle controller 350, a conveyance controller 342, a saddle binding controller 343, a half-folding controller 344, a square back process controller 345, and a communication portion 341. The saddle controller 350 includes a CPU 351, a ROM 352, and a RAM 353 similarly to the controller 310. The conveyance controller 342 controls the various conveyance rollers that convey the sheet and the switching members that switch the conveyance path in the saddle portion B2. The saddle binding controller 343 controls the saddle binding processing portion 104. The half-folding controller 344 controls a half-folding processing mechanism C1. The square back process controller 345 controls a square back processing portion C2. The communication portion 341 communicably connects the communication portion 321 of the sheet processing apparatus B with the saddle controller 350.

### Saddle Portion

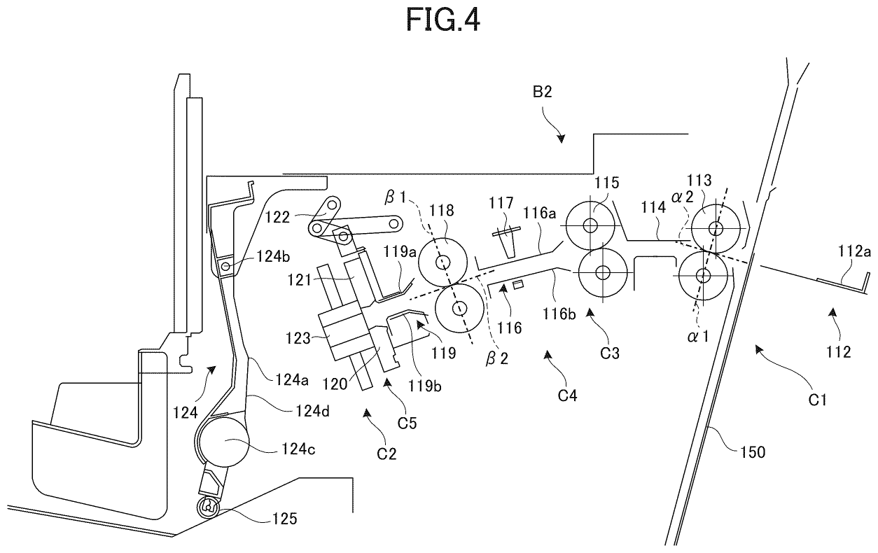

The saddle portion B2 will be described with reference to FIGS. 2 and 4. The saddle portion B2 includes the half-folding processing mechanism C1 and the square back processing portion C2. The half-folding processing mechanism C1 accumulates sheets conveyed from the conveyance path 28 for each copy to form a sheet bundle, performs a binding process on a center portion in the conveyance direction (center portion in a second conveyance direction that is a conveyance direction of the saddle path roller 100 serving as a second conveyance portion that will be described later) of the sheet bundle, and performs a half-folding process (hereinafter also referred to as a “magazine finish”) in which the sheet bundle is folded at a position subjected to the binding process. The square back processing portion C2 is disposed downstream of the half-folding processing mechanism C1 in the conveyance direction of the sheet bundle (downstream in the first conveyance direction that is the conveyance direction of a saddle third roller pair 118 serving as a first conveyance unit that will be described later), and performs a square back process of forming a folding line on the spine of the sheet bundle subjected to the half-folding process. Further, the saddle discharge unit 131 is disposed downstream of the square back processing portion C2 in the first conveyance direction, and the sheet bundle subjected to a bookbinding process is stacked on the saddle discharge unit 131. To be noted, only the half-folding process of folding the center portion of the sheet in the conveyance direction may be performed without performing the saddle binding process and the square back process after accumulating one sheet or a plurality of sheets for each copy.

### Half-Folding Mechanism

The half-folding processing mechanism C1 includes a leading end regulating stopper 109, a saddle binding processing portion (saddle binding stapling unit) 104, and a half-folding processing portion 112 serving as a half-folding processing unit, accumulates sheets into a bundle shape, and performs the half-folding process and the saddle binding process. That is, the sheet conveyed from the conveyance path 28 to the saddle path 32 is conveyed to the saddle stacking tray 150 serving as an accumulation portion and a second accumulation portion by the saddle path roller 100 serving as a second conveyance portion. The saddle stacking tray 150 forms a sheet bundle by accumulating a plurality of sheets conveyed in the second conveyance direction by the saddle path roller 100 through the saddle path 32. The sheet bundle accumulated on the saddle stacking tray 150 is positioned at a predetermined position on the saddle stacking tray 150 by the leading end regulating stopper 109.

The saddle stacking tray 150 is provided with a saddle stacking sensor 106 serving as a sheet detection portion that detects the presence or absence of the sheet. The saddle stacking sensor 106 may be provided at any position as long as the presence or absence of the sheet on the saddle stacking tray 150 can be detected. In the present embodiment, the saddle stacking sensor 106 is disposed at a position not interfering with the operation of a folding plate 112a and in the vicinity of the folding roller pair 113. For example, the saddle stacking sensor 106 is preferably disposed between the saddle binding processing portion 104 and the folding plate 112a, and is more preferably disposed between a pull-in separation roller 105 and the folding plate 112a.

The saddle binding processing portion 104 serving as a second binding processing portion (saddle binding unit) performs the binding process (saddle binding process) on a center portion in the conveyance direction (middle portion in the second conveyance direction) of the sheet bundle positioned by the leading end regulating stopper 109. The half-folding processing portion 112 includes the folding plate 112a and the folding roller pair 113, and by conveying the sheet bundle by the folding roller pair 113 while poking the vicinity of the position subjected to the binding process by the saddle binding processing portion 104 (center portion in the conveyance direction of the sheet bundle in the binding process) by the folding plate 112a, the sheet bundle is folded and conveyed such that the spine of the sheet bundle is on the downstream side in the conveyance direction.

The saddle binding processing portion 104 is a mechanism that performs the binding process of moving a head unit and an anvil unit along the sheet center portion (line) while nipping the sheet bundle between the head unit and the anvil unit. In addition, for the half-folding processing portion 112, as illustrated in FIGS. 2 and 4, a configuration in which the sheet bundle is inserted in the nip of the folding roller pair 113 in pressure contact with each other by the folding plate 112a, and the sheet bundle is conveyed while being folded by the rotation of the folding roller pair 113 is employed.

### Square Back Processing Portion

The square back processing portion C2 performs the square back process to make the folding line of the sheet bundle subjected to the half-folding process into a square back shape. The square back processing portion C2 includes a lower clamp unit 120 and an upper clamp unit 121 serving as a pair of clamp portions, and a square back processing unit 134 including a pressing roller 123. The lower clamp unit 120 and the upper clamp unit 121 relatively move along the thickness direction of the sheet bundle conveyed by a saddle third roller pair 118 that will be described later, and thus nip the sheet bundle and release the nipping of the sheet bundle. The pressing roller 123 moves along the width direction of the sheet bundle (direction orthogonal to the conveyance direction of the sheet bundle, front-rear direction of FIGS. 2 and 4), and thus presses the spine of the sheet bundle. Further, the square back processing portion C2 performs a square back process of forming a corner on the spine of the sheet bundle by pressing, by the pressing roller 123, the spine of the sheet bundle nipped between the lower clamp unit 120 and the upper clamp unit 121 in a state in which the spine of the sheet bundle protrudes downstream with respect to the lower clamp unit 120 and the upper clamp unit 121 in the first conveyance direction. To be noted, examples of the “corner” described above include a curved surface, and refers to a boundary between the front cover and the spine of the sheet bundle and a boundary between the spine and the back cover of the sheet bundle.

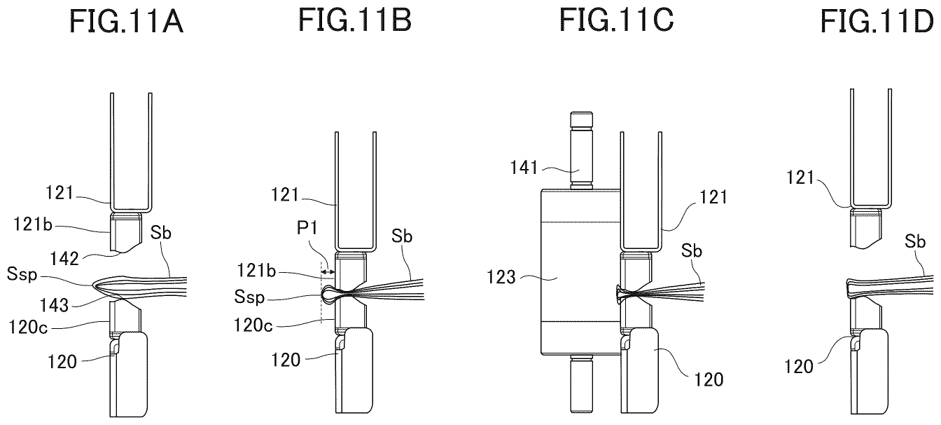

Specifically, the square back processing portion C2 nips part of the sheet bundle from both sides in the vertical direction (thickness direction of the sheet bundle) in a state in which the spine of the sheet bundle subjected to the half-folding by the half-folding processing mechanism C1 protrudes downstream in the first conveyance direction. The pressing roller 123 presses the spine of the sheet bundle nipped between the lower clamp unit 120 and the upper clamp unit 121, in the width direction of the sheet bundle orthogonal to the conveyance direction of the sheet bundle and to the thickness direction of the sheet bundle. In this manner, the square back processing portion C2 performs the square back process of forming a corner on the spine of the sheet bundle. The square back process is a process of forming two corners on the spine of the sheet bundle by forming two streaks on the spine of the sheet bundle as illustrated in FIGS. 11C and 11D by crushing the spine of the sheet bundle illustrated in FIGS. 11A and 11B that will be described later by the pressing roller 123. The two corners on the spine of the sheet bundle are formed at positions between which the staples embedded in the sheet bundle in the binding process by the saddle binding processing portion 104 are positioned in the thickness direction of the sheet bundle. In addition, the two corners formed on the spine of the sheet bundle are formed at positions between which a folding line formed in the half-folding process by the half-folding processing portion 112 is positioned.

To be noted, a half-folding conveyance mechanism that conveys the sheet bundle subjected to the half-folding process by the half-folding processing mechanism C1 to the square back processing portion C2 positioned downstream and stops the conveyance is disposed between the half-folding processing mechanism C1 and the square back processing portion C2.

As described above, the processing portion B1 and the conveyance path 28 are arranged in approximately the horizontal direction, the saddle path 32 that guides the sheet to the saddle portion B2 is disposed in approximately the vertical direction, and the saddle stacking tray 150 that accumulates the sheets for each copy is disposed to approximately follow the vertical direction. As described above, by disposing the conveyance path 28 along a direction traversing the housing 27 and disposing the saddle path 32 and the saddle portion B2 along approximately the vertical direction, the apparatus can be made slimer, that is, the width of the apparatus in the horizontal direction can be reduced.

The saddle discharge unit 131 is disposed downstream of the saddle portion B2 in the conveyance direction of the sheet bundle, and accommodates a sheet bundle folded into a magazine shape. The saddle discharge unit 131 that is illustrated is disposed below the first tray 49 in the vertical direction. This is because the apparatus has specifications set in consideration of the fact that the frequency of use of the first tray 49 is higher than the frequency of use of the saddle discharge unit 131 and the first tray 49 is set to a height where the sheet on the tray is easy to pick up.

### Configuration of Saddle Portion

Next, the configuration of each of the half-folding processing mechanism C1, the half-folding conveyance mechanism C3, and the square back processing portion C2 constituting the saddle portion B2 will be described in more detail.

### Details of Half-Folding Processing Mechanism

As illustrated in FIG. 2, the saddle path switching member 33 is switched so as to convey the sheet to the saddle path 32, and thus guides the sheet to the half-folding processing mechanism C1. A saddle inlet roller 101, a sorting portion 102, a trailing end pressing guide 103, a saddle binding processing portion 104, a pull-in separation roller 105, a half-folding processing portion 112, a first alignment roller 107, a second alignment roller 108, a leading end regulating stopper 109, and a leading end gripper 110 are disposed in this order from the upper side (upstream side) in the vertical direction that is the inlet side in the height direction of the half-folding processing mechanism C1.

The saddle inlet roller 101 conveys the sheet passed on thereto from the saddle path 32 by the saddle path roller 100 further downward. The sorting portion 102 moves the sheet conveyed downward from the saddle inlet roller 101 to the right side in FIG. 2, and accumulates the sheet on the saddle stacking tray 150. The trailing end pressing guide 103 presses the trailing end of the sheet stacked on the saddle stacking tray 150. The saddle binding processing portion 104 performs the binding process on the center portion in the conveyance direction of the sheet bundle accumulated on the saddle stacking tray 150. The pull-in separation roller 105 supports the conveyance of the sheet conveyed to the saddle stacking tray 150, and is a roller that pulls in this sheet toward the leading end regulating stopper 109. The pull-in separation roller 105 is disposed so as to be capable of coming into contact and out of contact with and from an opposing roller 105a.

The half-folding processing portion 112 includes a folding roller pair 113, the folding plate 112a serving as a pressing portion, and a roller guide 111. The folding roller pair 113 forms a folding line in the half-folding process. The folding plate 112a pushes the sheet into the nip portion of the folding roller pair 113. That is, the folding roller pair 113 performs half-folding on the sheet bundle by nipping and conveying the sheet bundle such that the spine of the sheet bundle is positioned downstream of the end portion of the sheet bundle on the fore edge side. The folding plate 112a presses the sheet bundle subjected to the saddle binding process by the saddle binding processing portion 104 toward the nip portion of the folding roller pair 113. The roller guide 111 covers the folding roller pair 113. The first alignment roller 107 and the second alignment roller 108 convey the sheet conveyed to the saddle stacking tray 150, and aligns the sheet in the height direction of the sheet. The leading end regulating stopper 109 abuts the leading end (lower end) of the sheet conveyed thereto, and determines the position of the leading end of the sheet in the height direction. The leading end gripper 110 presses the leading end (lower end) of the sheet stacked on the leading end regulating stopper 109.

The saddle inlet roller 101 and the pull-in separation roller 105 are driven by the same motor. The trailing end pressing guide 103 is at a position opposing the sorting portion 102 with the saddle stacking tray 150 therebetween. The saddle binding processing portion 104 is disposed downstream of the sorting portion 102 and the trailing end pressing guide 103 and upstream of the pull-in separation roller 105.

The sheet conveyed from the saddle path 32 to the saddle portion B2 is conveyed to the leading end regulating stopper 109 moved to a position corresponding to the size by the saddle inlet roller 101. The pull-in separation roller 105 has an auxiliary conveyance function for precisely conveying the conveyed sheet to the leading end regulating stopper 109 in the saddle stacking tray 150. The roller guide 111 covers the folding roller pair 113 so as to suppress the leading end of the sheet getting caught at the folding roller pair 113 at this time and efficiently convey the sheet.

The first alignment roller 107 and the second alignment roller 108 cause the conveyed sheet to precisely abut the leading end regulating stopper 109, and thus performs an alignment process in the sheet height direction.

The sorting portion 102 moves the sheet conveyed to the leading end regulating stopper 109 to the trailing end pressing guide 103, and by pressing the trailing end (upper end) of the moved sheet by the trailing end pressing guide 103, preparation for receiving the next sheet is performed. At this time, the trailing end pressing guide 103 has moved to a position corresponding to the size and is standing by.

The leading end (trailing end) of the sheet bundle formed by stacking a plurality of sheets on the saddle stacking tray 150 is fixed by being gripped by the leading end gripper 110. In this state, the binding process is performed on the center portion in the second conveyance direction of the sheet bundle by the saddle binding processing portion 104. After the binding process, the leading end regulating stopper 109 is moved down while the leading end (lower end) of the sheet bundle is still gripped by the leading end gripper 110. At this time, by moving down the leading end regulating stopper 109 such that the position in the sheet where the sheet is pushed into the folding roller pair 113 by the folding plate 112a is a position of ½ of the sheet size, the sheet bundle is moved down from the binding position.

When performing the half-folding process, the roller guide 111 is retracted, the fixation by the leading end gripper 110 is released, and then the center portion of the sheet bundle is pushed into the nip portion of the folding roller pair 113 by the folding plate 112a. As a result of this, the half-folding process is performed on the sheet bundle.

The saddle inlet roller 101, the pull-in separation roller 105, the sorting portion 102, and the trailing end pressing guide 103 are controlled by the conveyance controller 342 (FIG. 3). In addition, the leading end regulating stopper 109, the leading end gripper 110, the saddle binding processing portion 104, the first alignment roller 107, and the second alignment roller 108 are controlled by the saddle binding controller 343 (FIG. 3). Further, the folding roller pair 113 and the folding plate 112a are controlled by the half-folding controller 344 (FIG. 3).

### Half-Folding Conveyance Mechanism

The configuration of the half-folding conveyance mechanism C3 will be described with reference to FIGS. 2 and 4. The half-folding conveyance mechanism C3 is a mechanism that passes on the sheet bundle subjected to the half-folding process by the half-folding processing mechanism C1 to the square back processing portion C2. Specifically, the half-folding conveyance mechanism C3 first conveys the sheet bundle subjected to the half-folding process as it is by the folding roller pair 113 such that the spine of the sheet bundle is positioned downstream of an end portion thereof on the fore edge side in the conveyance direction, and passes on the sheet bundle to the post-folding path guide 114. The post-folding path guide 114 is disposed at a position downstream of the folding roller pair 113 in the conveyance direction and is disposed along a direction (approximately horizontal direction herein) bending downward in the vertical direction from a folding roller conveyance direction 113c (FIG. 2) following a line (first virtual line α2 that will be described later, FIG. 4) perpendicular to a straight line passing through the rotational center of each roller of the folding roller pair 113 serving as a first conveyance roller pair.

Here, as illustrated in FIG. 4, a straight line orthogonal to a first line a1 passing through the rotational centers of the folding roller pair 113 and to the width direction (direction orthogonal to the conveyance direction of the sheet bundle, front-rear direction of FIGS. 2 and 4) and passing through the nip of the folding roller pair 113 not nipping the sheet bundle is set as the first virtual line α2. In this case, the folding roller pair 113 is disposed such that the first virtual line α2 is parallel to the horizontal direction or is inclined upward in the vertical direction toward the downstream side in the conveyance direction with respect to the horizontal direction. In the present embodiment, the first virtual line α2 is inclined upward in the vertical direction toward the downstream side in the conveyance direction with respect to the horizontal direction. In contrast, the post-folding path guide 114 is provided to extend in a direction inclined with respect to the first virtual line α2, and is provided to extend approximately in the horizontal direction in the present embodiment.

The post-folding path guide 114 guides the conveyance of the sheet bundle, and guides the sheet bundle to a saddle second roller pair 115 positioned on the downstream side in the conveyance direction. A saddle second roller conveyance direction 115c that is a direction following a line perpendicular to a straight line passing through the rotational center of each roller of the saddle second roller pair 115 is provided along a direction inclined downward in the vertical direction toward the downstream side in the conveyance direction. The saddle second roller pair 115 is driven by the half-folding controller 344 and conveys the sheet bundle.

The sheet bundle conveyed by the saddle second roller pair 115 is passed on to the post-second roller path guide 116 disposed on the downstream side in the conveyance direction and disposed parallel to the saddle second roller conveyance direction 115c (FIG. 2), and is guided by the post-second roller path guide 116. In addition, the post-second roller path guide 116 includes a post-second roller path upper guide 116a that guides the upper surface of the sheet bundle and a post-second roller path lower guide 116b that guides the sheet bundle. A saddle conveyance sensor 117 serving as a detection portion is disposed at a position above the guide surface of the post-second roller path upper guide 116a and between the inlet port for the sheet bundle and the discharge port for the sheet bundle. The saddle conveyance sensor 117 detects the position of the leading end of the sheet bundle.

The post-second roller path guide 116 guides the conveyance of the sheet, and guides the sheet to the saddle third roller pair 118 positioned downstream in the conveyance direction. A saddle third roller conveyance direction 118c (FIG. 2) that is a direction following a line (second virtual line B2 that will be described next, FIG. 4) perpendicular to a straight line passing through the rotational center of each roller of the saddle third roller pair 118 is provided along a direction inclined downward in the vertical direction toward the downstream side in the conveyance direction.

The saddle third roller pair 118 serving as a conveyance roller pair is driven by the half-folding controller 344, and nips and conveys the sheet bundle subjected to the saddle binding process and the half-folding process such that the spine of the sheet bundle is positioned downstream of an end portion on the fore edge side in the conveyance direction. That is, the saddle third roller pair 118 conveys the sheet bundle such that the spine of the sheet bundle serves as the leading end. In the case where the direction in which the sheet bundle is conveyed by the saddle third roller pair 118 serving as a conveyance unit and a first conveyance unit is set as the first conveyance direction (saddle third roller conveyance direction 118c), the saddle path roller 100 serving as a second conveyance unit that conveys the sheet to the half-folding processing mechanism C1 is positioned upstream of the saddle third roller pair 118 in the first conveyance direction. Further, the saddle path roller 100 conveys the sheet in a second conveyance direction different from the first conveyance direction at a position upstream of the saddle third roller pair 118 in the first conveyance direction. In the description below, the upstream side and the downstream side in the first conveyance direction (saddle third roller conveyance direction 118c) in which the sheet bundle is conveyed by the saddle third roller pair 118 may be sometimes simply referred to as the “upstream side” and the “downstream side”.

To be noted, the folding roller pair 113, the saddle second roller pair 115, and the saddle third roller pair 118 are driven by the same motor, and the half-folding controller 344 controls this motor to control the driving of each roller pair. The saddle third roller pair 118 nips the sheet bundle subjected to half-folding by the half-folding processing portion 112, conveys the sheet bundle toward the square back processing portion C2, and is positioned immediately upstream of the square back processing portion C2.

Here, as illustrated in FIG. 4, a straight line that is orthogonal to a second line β1 passing through the rotational centers of the saddle third roller pair 118 and to the width direction and that passes the nip of the saddle third roller pair 118 not nipping the sheet bundle is set as a second virtual line β2. In this case, the saddle third roller pair 118 is provided such that the second virtual line β2 intersects with the first virtual line α2 and is inclined downward in the vertical direction toward the downstream side of the folding roller pair 113 in the conveyance direction.

In other words, the saddle third roller pair 118 is disposed such that the second virtual line β2 is inclined downward in the vertical direction toward the downstream side in the conveyance direction with respect to the horizontal direction. That is, in the present embodiment, the second virtual line β2 is inclined with respect to the first virtual line α2. Further, the folding roller pair 113 conveys the sheet bundle in the horizontal direction or a direction (folding roller conveyance direction 113c) inclined upward in the vertical direction toward the downstream side in the conveyance direction with respect to the horizontal direction. In contrast, the saddle third roller pair 118 conveys the sheet bundle in a direction (saddle third roller conveyance direction 118c) inclined downward in the vertical direction toward the downstream side in the conveyance direction with respect to the horizontal direction.

Therefore, in the case of the present embodiment, the half-folding conveyance path C4 serving as a third conveyance path in which the sheet bundle is conveyed between the folding roller pair 113 and the saddle third roller pair 118 is bent such that the sheet bundle conveyed by the folding roller pair 113 is passed on to the saddle third roller pair 118. That is, the half-folding conveyance path C4 includes the post-folding path guide 114 and the post-second roller path guide 116, and the conveyance path between the post-folding path guide 114 and the post-second roller path guide 116 is bent. In other words, the direction in which the sheet bundle is guided by the post-second roller path guide 116 is inclined with respect to the direction in which the sheet bundle is guided by the post-folding path guide 114.

As described above, by making the conveyance direction of the sheet bundle by the folding roller pair 113 and the conveyance direction of the sheet bundle by the saddle third roller pair 118 different and bending the conveyance path between the post-folding path guide 114 and the post-second roller path guide 116, the width (length in the second conveyance direction, length in the left-right direction of FIG. 2) of the sheet processing apparatus B can be reduced, and thus the apparatus can be miniaturized. In addition, by discharging the sheet bundle downward by the saddle third roller pair 118 with the folding roller conveyance direction 113c serving as the sheet conveyance direction of the saddle third roller pair 118 directed diagonally downward, the sheet bundle processed by the saddle portion B2 can be discharged to a position lower in the apparatus.

As a result of this, the saddle discharge unit 131 to which the sheet bundle processed by the saddle portion B2 is discharged can be disposed in a lower portion of the apparatus, and thus the amount by which the first tray 49 positioned above the saddle discharge unit 131 can be moved down can be increased. As a result of this, the sheet stacking amount of the first tray 49 can be increased while miniaturizing the sheet processing apparatus B. To be noted, in the case where “horizontal”, “vertical”, “parallel”, and the like are mentioned in the layout of the conveyance path guides for the sheet or sheet bundle and the conveyance direction of the sheet or sheet bundle, cases where an angle is formed with respect to the horizontal direction, the vertical direction, or the parallel direction due to the tolerance or the like are also included.

### Details of Square Back Processing Portion

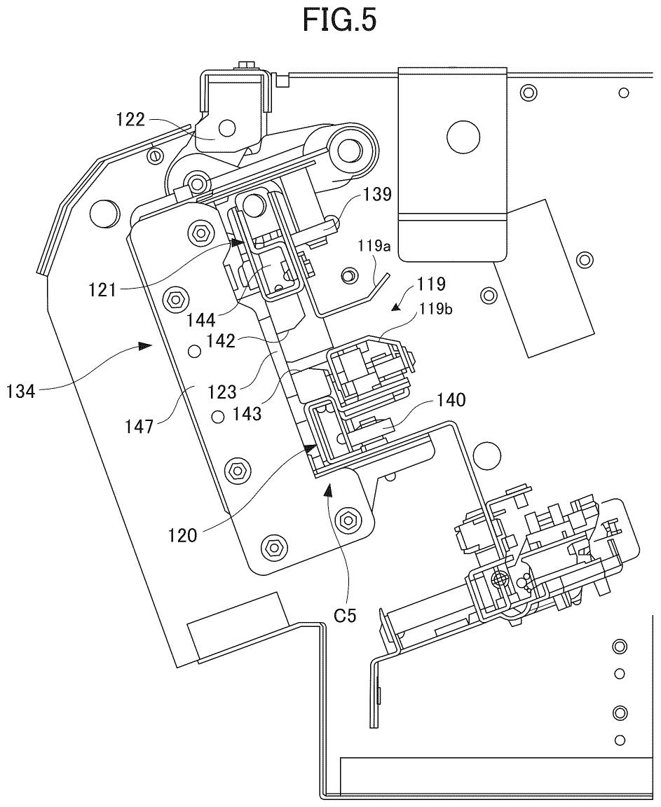

The square back processing portion C2 will be described by using FIGS. 5 to 10 with reference to FIGS. 2 and 4. As described above, the square back processing unit 134 including the lower clamp unit 120 and the upper clamp unit 121 serving as a pair of clamp portions and the pressing roller 123 is provided. A clamping mechanism C5 including the lower clamp unit 120 and the upper clamp unit 121 includes a pre-clamp guide 119 as illustrated in FIG. 5. The pre-clamp guide 119 is disposed at a position downstream of the saddle third roller pair 118 in the conveyance direction and is disposed along a direction bent downward in the vertical direction with respect to the saddle third roller conveyance direction 118c, and guides the conveyance of the sheet bundle.

The pre-clamp guide 119 includes a pre-clamp upper guide portion 119a serving as a first guide portion that guides the upper surface of the sheet bundle, and a pre-clamp lower guide portion 119b serving as a second guide portion that guides the lower surface of the sheet bundle. The pre-clamp upper guide portion 119a and the pre-clamp lower guide portion 119b are disposed at positions apart from a line centered on the saddle third roller conveyance direction 118c by a distance larger than a half of the maximum thickness of the sheet bundle that can be passed through the apparatus (the thickness of the sheet bundle after performing the half-folding process on the sheet bundle of the maximum thickness that can be conveyed in the apparatus). That is, the distance between the pre-clamp upper guide portion 119a and the pre-clamp lower guide portion 119b is larger than the maximum thickness of the sheet bundle that can be processed by the sheet processing apparatus B (maximum thickness of the sheet bundle that can be subjected to the half-folding process by the half-folding processing mechanism C1). To be noted, at least one of the pre-clamp upper guide portion 119a and the pre-clamp lower guide portion 119b may be omitted.

The lower clamp unit 120 and the upper clamp unit 121 are relatively movable to a first position where the sheet bundle conveyed from the saddle third roller pair 118 can be received and a second position where the sheet bundle is nipped. Further, the lower clamp unit 120 and the upper clamp unit 121 move from the first position to the second position and thus nip part of the sheet bundle from both sides in the thickness direction of the sheet bundle.

In the case of the present embodiment, the upper clamp unit 121 serving as a first clamp portion is movable, and the lower clamp unit 120 serving as a second clamp portion is fixed. That is, the upper clamp unit 121 moves in a direction to approach the lower clamp unit 120, and thus the sheet bundle is nipped. To be noted, a configuration in which the upper clamp unit 121 is fixed and the lower clamp unit 120 is movable may be employed, and a configuration in which both of these are movable may be employed. In either case, an upper clamping surface (upper clamping pressing portion) 142 of the upper clamp unit 121 that is a surface opposing the lower clamp unit 120 and a lower clamping surface (lower clamping pressing portion) 143 of the lower clamp unit 120 that is a surface opposing the upper clamp unit 121 nip the sheet bundle (see FIGS. 5 and 11A to 11D).

The lower clamping surface 143 of the lower clamp unit 120 and the upper clamping surface 142 of the upper clamp unit 121 are respectively parallel to the pre-clamp upper guide portion 119a and the pre-clamp lower guide portion 119b and are disposed downstream of the pre-clamp guide 119 in the conveyance direction of the sheet bundle. Further, the sheet bundle conveyed while being guided by the pre-clamp guide 119 is conveyed by a predetermined amount while further being guided by the upper clamping surface 142 and the lower clamping surface 143. To be noted, the pre-clamp lower guide portion 119b and the pre-clamp upper guide portion 119a are respectively fixed to the lower clamp unit 120 and the upper clamp unit 121. In the present embodiment, the pre-clamp upper guide portion 119a moves approximately in the vertical direction (thickness direction of the sheet bundle) together with the upper clamp unit 121. The upper clamp unit 121 and the lower clamp unit 120 are disposed at positions apart from a line centered on the saddle third roller conveyance direction 118c by a distance larger than a half of the maximum thickness of the sheet bundle that can be passed through the apparatus (the thickness of the sheet bundle after performing the half-folding process on the sheet bundle of the maximum thickness that can be conveyed in the apparatus) at the first position similarly to the pre-clamp upper guide portion 119a and the pre-clamp lower guide portion 119b.

### Square Back Processing Unit

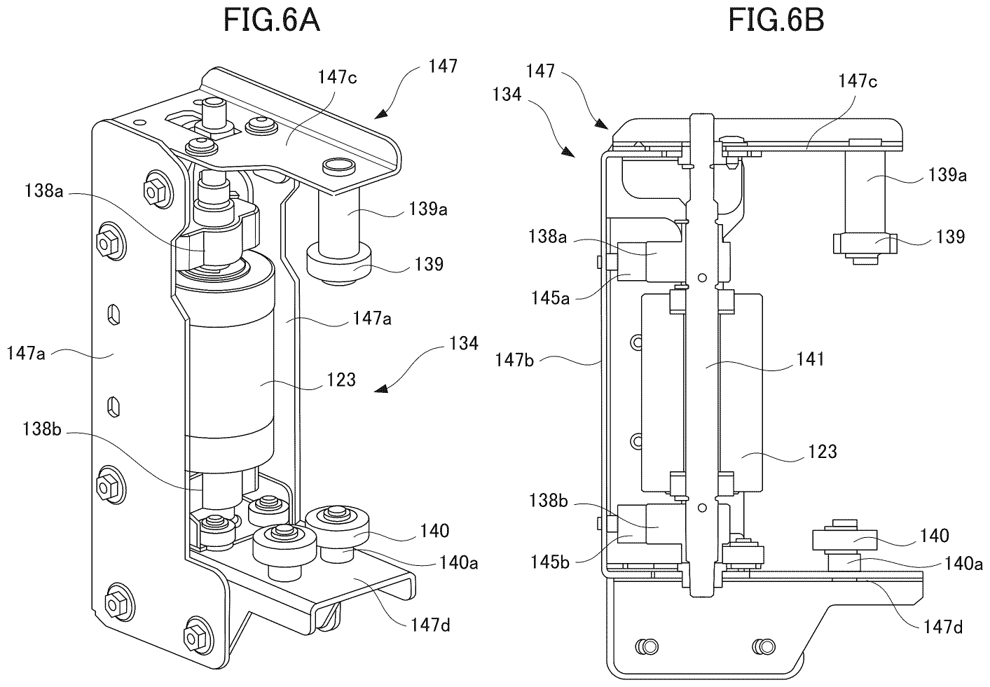

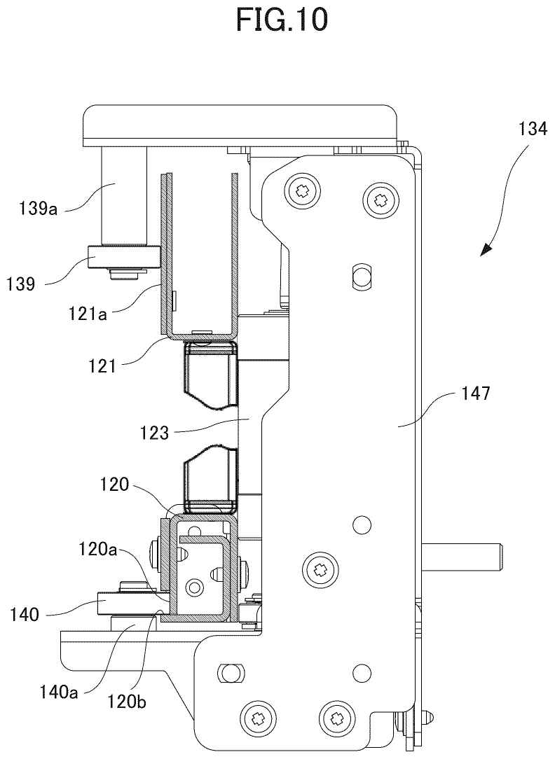

Next, an inner configuration of the square back processing unit 134 will be described with reference to FIGS. 5 to 10. The square back processing unit 134 includes a pressing roller (square back processing roller) 123, a unit frame 147, roller pressurizing portions 138a and 138b, pressurizing springs 145a and 145b, an upper movement regulating portion 139, and a lower movement regulating portion 140. The pressing roller 123 is disposed such that the outer peripheral surface thereof is in contact with a downstream end surface of each of the lower clamp unit 120 and the upper clamp unit 121 as illustrated in FIGS. 5 and 10. In addition, a roller shaft 141 is disposed on the radially inner side of the pressing roller 123, and the pressing roller 123 is rotatable with respect to the roller shaft 141 as illustrated in FIG. 6B.

As illustrated in FIGS. 6A and 6B, the unit frame 147 includes a pair of side plates 147a disposed on the two sides of the pressing roller 123, a rear side plate 147b disposed on the left side of the downstream side (FIG. 6B) in the first conveyance direction of the pressing roller 123, and an upper side plate 147c and a lower side plate 147d that are provided on the two sides of the pressing roller 123 in the rotational axis direction so as to be bent from two end portions of the rear side plate 147b. The unit frame 147 is configured in this manner, and thus accommodates the pressing roller 123 in a space enclosed by the side plates and exposes the pressing roller 123 on the upstream side in the first conveyance direction.

In the present embodiment, the rear side plate 147b, the upper side plate 147c, and the lower side plate 147d are formed integrally, and has an approximate C shape in section view as illustrated in FIG. 6B. To be noted, these may be formed as separate members, or may be formed integrally with the pair of side plates 147a. The two end portions of the roller shaft 141 of the pressing roller 123 are respectively rotatably supported by the upper side plate 147c and the lower side plate 147d. In addition, the upper side plate 147c and the lower side plate 147d are provided to extend upstream of the pressing roller 123 in the first conveyance direction, and the upper movement regulating portion 139 and the lower movement regulating portion 140 are respectively supported at distal end portions of the upper side plate 147c and the lower side plate 147d.

That is, the upper movement regulating portion 139 is provided at a distal end portion of a support shaft 139a fixed to the upper side plate 147c and provided to extend downward from the upper side plate 147c. In addition, the lower movement regulating portion 140 is provided at a distal end portion of a support shaft 140a fixed to the lower side plate 147d and provided to extend upward from the lower side plate 147d. In addition, the upper movement regulating portion 139 is a roller rotatably provided at the distal end portion of the support shaft 139a, and the lower movement regulating portion 140 is a roller rotatably provided at the distal end portion of the support shaft 140a. To be noted, although two lower movement regulating portions 140 are provided side by side in the present embodiment, the number of the lower movement regulating portions 140 may be one. In addition, two upper movement regulating portions 139 may be also provided. The upper movement regulating portion 139 and the lower movement regulating portion 140 are positioned on the respective sides of the pressing roller 123 in the rotational axis direction of the roller shaft 141.

The roller pressurizing portions 138a and 138b are each coupled to the roller shaft 141 from the outside in the roller thickness direction of the pressing roller 123 and from the downstream side in the conveyance direction. Pressurizing springs 145a and 145b are disposed between the roller pressurizing portions 138a and 138b and the rear side plate 147b of the unit frame 147, and the roller shaft 141 is urged by the pressurizing springs 145a and 145b. The roller shaft 141 is configured to be movable in the conveyance direction, and therefore the pressurizing force by which the pressing roller 123 pressurizes the spine of the sheet bundle by the urging force of the pressurizing springs 145a and 145b changes in accordance with the change in the protruding amount of the spine of the sheet bundle from the lower clamp unit 120 and the upper clamp unit 121 that will be described later.

In addition, the pressing roller 123 is urged by the pressurizing springs 145a and 145b via the roller shaft 141, and is therefore pressurized by the lower clamp unit 120 and the upper clamp unit 121. In contrast, the upper movement regulating portion 139 and the lower movement regulating portion 140 are disposed on the opposite side to the pressing roller 123 across the lower clamp unit 120 and the upper clamp unit 121 so as to respectively oppose the lower clamp unit 120 and the upper clamp unit 121 (FIG. 5). That is, the upper movement regulating portion 139 and the lower movement regulating portion 140 are disposed on the upstream side of the lower clamp unit 120 and the upper clamp unit 121 in the conveyance direction of the sheet bundle (first conveyance direction) so as to respectively oppose the upper clamp unit 121 and the lower clamp unit 120.

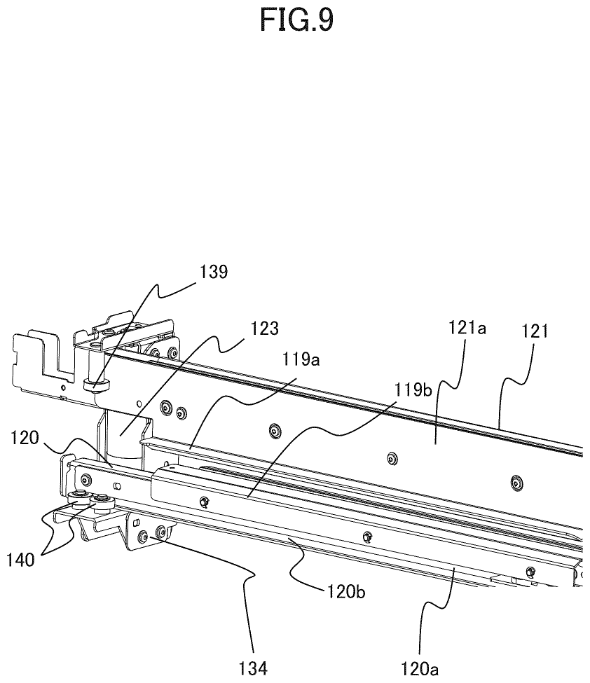

As illustrated in FIGS. 9 and 10, an end surface 120a on the upstream side of the lower clamp unit 120 is in contact with the lower movement regulating portion 140. In addition, an end surface 121a on the upstream side of the upper clamp unit 121 is in contact with the upper movement regulating portion 139. In the present embodiment, the lower movement regulating portion 140 and the upper movement regulating portion 139 are each a roller having a rotation shaft in a direction (up-down direction of FIG. 10, an approximately vertical direction in the present embodiment) orthogonal to the width direction of the sheet bundle and the conveyance direction of the sheet bundle, and respectively rotate in contact with the end surfaces 120a and 121a. As a result of this, upstream movement of the lower clamp unit 120 and the upper clamp unit 121 caused by the pressurizing force applied from the pressing roller 123 to the lower clamp unit 120 and the upper clamp unit 121 is restricted.

The conveyance amount of the sheet bundle conveyed by the saddle third roller pair 118 is counted by the square back process controller 345 when the leading end of the sheet bundle is detected by the saddle conveyance sensor 117 described above, and the sheet bundle is stopped after being conveyed by a predetermined conveyance amount. Specifically, as illustrated in FIG. 11A that will be described later, the sheet bundle is stopped in a state in which the spine of the sheet bundle subjected to the half-folding protrudes downstream in the conveyance direction more than the upper clamp unit 121 and the lower clamp unit 120. In the present embodiment, in the square back process, the conveyance amount of the sheet bundle by the saddle third roller pair 118 is controlled, and thus the protruding amount of the spine of the sheet bundle from the upper clamp unit 121 and the lower clamp unit 120 is adjusted.

### Upper Clamp Unit and Lower Clamp Unit

The upper clamp unit 121 moves from a receiving position (first position) for receiving the sheet bundle to a clamp holding position (second position) for holding the sheet bundle, thus the sheet bundle is pressurized between the upper clamp unit 121 and the lower clamp unit 120, and the sheet bundle is held by the upper clamping surface 142 and the lower clamping surface 143. At this time, the leading end of the sheet bundle protrudes by a predetermined protruding amount P1 from respective end surfaces 120c and 121b on the downstream side of the lower clamp unit 120 and the upper clamp unit 121 after the clamp holding in the conveyance direction as illustrated in FIG. 11B.

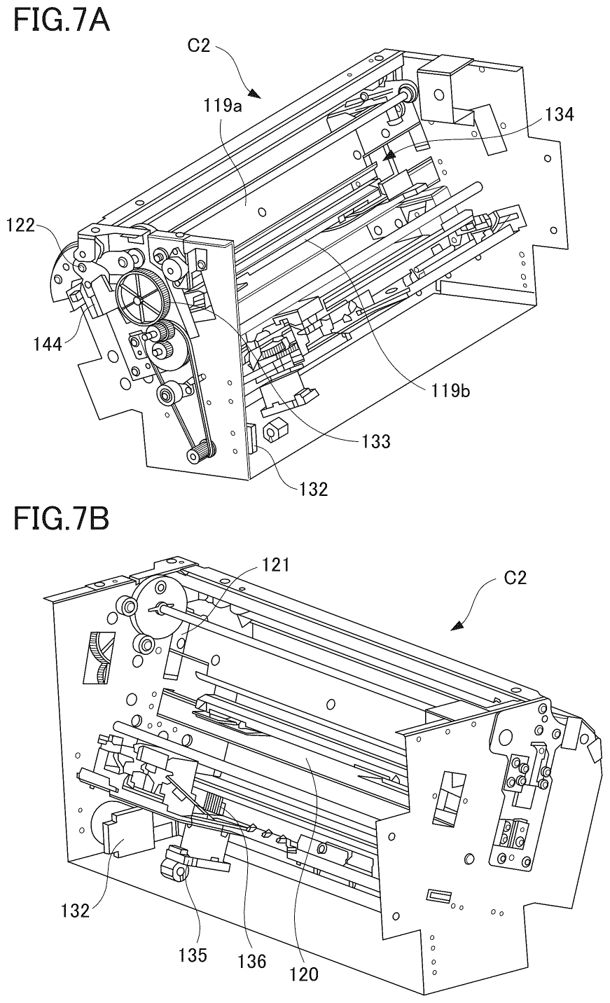

The upper clamp unit 121 operates by driving a clamp driving motor 132 (FIGS. 7A and 7B) by the square back process controller 345. As illustrated in FIGS. 7A and 7B, the square back processing portion C2 transmits a drive transmitted by a clamp driving train 133 constituted by a pulley, a belt, and a gear train further to a clamp driving link 122, and thus moves the upper clamp unit 121 connected to the clamp driving link 122 in the thickness direction of the sheet bundle. A plurality of clamp springs 144 that pressurize the sheet bundle are provided between the clamp driving link 122 and the upper clamp unit 121, and while the movement amount of the clamp driving link 122 remains constant, the contraction amount of the clamp spring 144 changes in accordance with the thickness of the sheet bundle, and thus the pressurizing force changes. The clamp holding position described above also changes in accordance with the thickness of the sheet bundle.

### Square Back Processing Portion

As illustrated in FIG. 11C that will be described later, the square back processing portion C performs the square back process on the sheet bundle held between the lower clamp unit 120 and the upper clamp unit 121 in a state of protruding from the end surfaces 120c and 121b by the predetermined protruding amount P1, by pressurizing the spine of the sheet bundle while moving, in the width direction of the sheet bundle in a scanning manner, the pressing roller 123 disposed on the downstream side in the conveyance direction. That is, in the square back process, the pressing roller 123 presses the spine of the sheet bundle nipped by the lower clamp unit 120 and the upper clamp unit 121 positioned at the second position by moving in the width direction in a state in which the spine of the sheet bundle conveyed by the saddle third roller pair 118 protrudes downstream in the conveyance direction of the saddle third roller pair 118 with respect to the lower clamp unit 120 and the upper clamp unit 121.

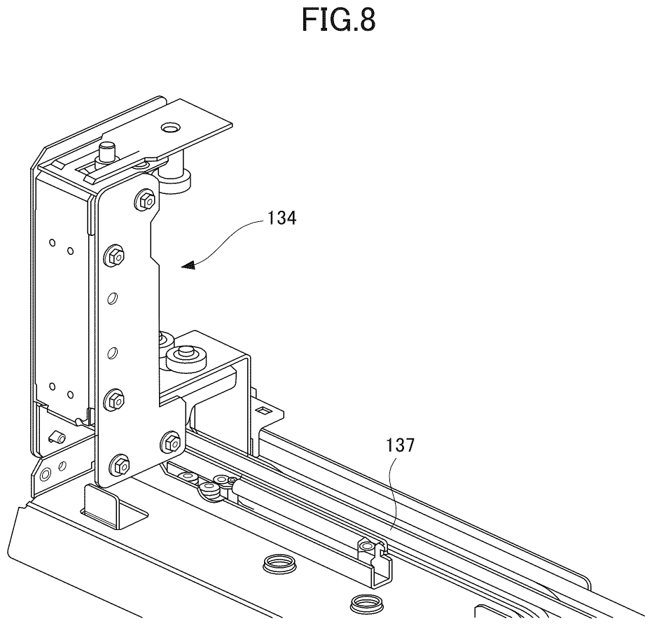

During the square back process, the square back processing unit 134 is moved by operating a driving motor 135 (FIG. 7B) by the square back process controller 345. The square back processing unit 134 is coupled to a driving belt 137 disposed in the width direction of the sheet bundle as illustrated in FIG. 8, and is movable in the width direction of the sheet bundle along a guide rail 120b illustrated in FIG. 9 that will be described later. The driving belt 137 rotates by receiving a driving force transmitted from the driving motor 135 via a driving train 136 (FIG. 7B) constituted by a gear train. As a result of this, the square back processing unit 134 can be moved in a scanning manner in the width direction of the sheet bundle. To be noted, the home position of the square back processing unit 134 is provided on the front side and the rear side of the sheet processing apparatus B. That is, after performing the square back process on the sheet bundle of the first copy by moving the square back processing unit 134 from the rear side to the front side, the square back process can be performed on the sheet bundle of the second copy by moving the square back processing unit 134 from the front side to the rear side. An unillustrated sensor is provided at each home position of the square back processing unit 134, and the position of the square back processing unit 134 can be detected. To be noted, a configuration in which the home position is provided on one of the front side and the rear side and the scanning movement of the square back processing unit 134 in the width direction is performed from the front side to the rear side or from the rear side to the front side may be employed. In the case where the home position is provided on only one side as described above, for example, after the square back process is performed on the sheet bundle of the first copy by moving the square back processing unit 134 from the rear side to the front side, the square back processing unit 134 may be moved back from the front side to the rear side, and then the square back process may be performed on the sheet bundle of the second copy also by moving the square back processing unit 134 from the rear side to the front side.

In addition, in one square back process, the pressing roller 123 is moved in one direction from the front side to the rear side or from the rear side to the front side, but the pressing roller 123 may be reciprocated in one square back process. For example, whether the pressing roller 123 is moved in one direction or reciprocated may be set in accordance with the number of sheets included in the sheet bundle or the type of the sheet. This setting may be automatically performed by the controller, or may be performed by an operator such as a user or a service person. Further, whether the pressing roller 123 is moved in one direction or reciprocated may be arbitrarily settable by the operator in each square back process.

The lower clamp unit 120 includes the guide rail 120b formed along the width direction of the sheet bundle as illustrated in FIGS. 9 and 10. The lower movement regulating portion 140 moves along the guide rail 120b in engagement with the guide rail 120b when the square back processing unit 134 moves in the width direction of the sheet bundle. The guide rail 120b is formed in an approximate C shape in section view by combining a plurality of members as illustrated in FIG. 10 such that part of the lower movement regulating portion 140 formed in a roller shape can enter the guide rail 120b. The lower surface of the radially outer side of the lower movement regulating portion 140 is engaged with the lower surface of the guide rail 120b, and the outer peripheral surface of the lower movement regulating portion 140 is in contact with the end surface 120a. As a result of this, the movement in the sheet bundle thickness direction is restricted when the square back processing unit 134 moves. To be noted, the guide rail 120b may be a groove formed in one member provided on the upstream side of the lower clamp unit 120 in the conveyance direction.

After the square back process is completed, the square back processing unit 134 is moved in the width direction and is thus retracted from the conveyance path of the sheet bundle by operating the driving motor 135 (FIG. 7B), and the upper clamp unit 121 is moved in a direction away from the sheet bundle (FIG. 11D that will be described later) by operating the clamp driving motor 132 (FIGS. 7A and 7B). As a result of this, the sheet bundle can be further conveyed downstream. To be noted, the sheet bundle can be also discharged without performing the square back process described above.

### Discharge Portion

As illustrated in FIG. 2, the sheet bundle having passed the saddle portion B2 is conveyed toward the saddle discharge guide 124 disposed further downstream of the square back processing unit 134 in the first conveyance direction, by the saddle third roller pair 118. The saddle discharge guide 124 serving as a discharge guide portion is supported to be swingable about a first fulcrum 124b including a rotation shaft parallel to the rotational axis of each roller of the saddle third roller pair 118. The first fulcrum 124b is positioned above an extension line of the conveyance direction (first conveyance direction, saddle third roller conveyance direction 118c) of the sheet bundle by the saddle third roller pair 118. Further, the saddle discharge guide 124 is disposed to hang down in the vertical direction from the first fulcrum 124b.

In addition, the saddle discharge guide 124 is formed such that the side surface thereof on the upstream side in the first conveyance direction is inclined upstream in the first conveyance direction from the first fulcrum 124b toward a middle portion 124a in the vertical direction. In addition, the side surface of the saddle discharge guide 124 on the upstream side in the first conveyance direction is inclined downstream in the first conveyance direction from the middle portion 124a toward the lower end in the vertical direction. That is, the side surface of the saddle discharge guide 124 on the upstream side in the first conveyance direction is formed such that the middle portion 124a in the vertical direction protrudes upstream in the first conveyance direction as compared with the other part. Further, in the side surface of the saddle discharge guide 124 on the upstream side in the first conveyance direction, a guide surface 124d is provided in a portion from the middle portion 124a to the lower end.

The guide surface 124d is positioned below an extension line obtained of the saddle third roller conveyance direction 118c, comes into contact with the sheet bundle conveyed by the saddle third roller pair 118, and guides the sheet bundle downward. The saddle discharge guide 124 is capable of pivoting about the first fulcrum 124b when the sheet bundle comes into contact with the guide surface 124d. To be noted, depending on the stiffness of the sheet bundle, there is a case where the sheet bundle does not come into contact with the guide surface 124d of the saddle discharge guide 124, and even in the case where the contact occurs, since the amount of the pivot changes depending on the stiffness, the saddle discharge guide 124 does not necessarily pivot.

In addition, a second fulcrum 124c is provided at a lower end portion of the saddle discharge guide 124, and a saddle discharge roller 125 that will be described later is coupled to the lower end portion of the saddle discharge guide 124 so as to be pivotable about the second fulcrum 124c. The second fulcrum 124c is positioned below the guide surface 124d, and includes a pivot shaft parallel to the pivot shaft of the first fulcrum 124b.

When the saddle third roller pair 118 continues conveying the sheet bundle, the sheet bundle is passed on to the saddle discharge unit 131 disposed at a position downstream of the square back processing unit 134 in the first conveyance direction and below the saddle discharge guide 124 in the vertical direction. The saddle discharge unit 131 includes a saddle discharge upstream tray 127, a saddle discharge upstream sensor 128, a saddle discharge tray 129, and a saddle discharge downstream sensor 130.

The saddle discharge upstream tray 127 includes an upstream belt 127a, and is positioned below the guide surface 124d of the saddle discharge guide 124. Further, on the saddle discharge upstream tray 127, the sheet bundle guided downward by the guide surface 124d is further guided and conveyed downstream by the upstream belt 127a. A stacking surface 127b of the saddle discharge upstream tray 127 for the sheet bundle is inclined downward in the vertical direction toward the downstream side in the conveyance direction.

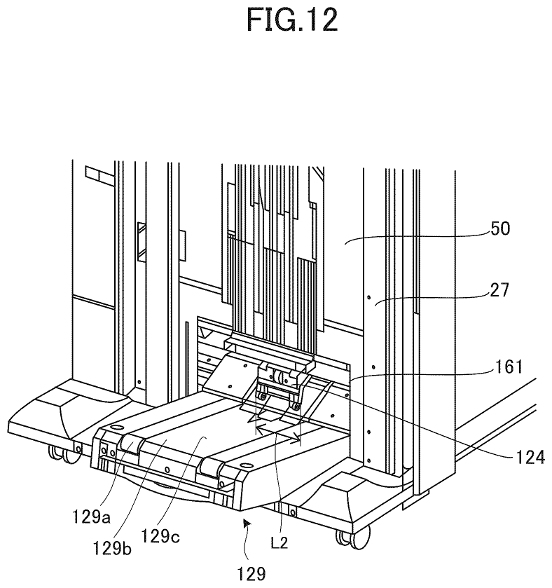

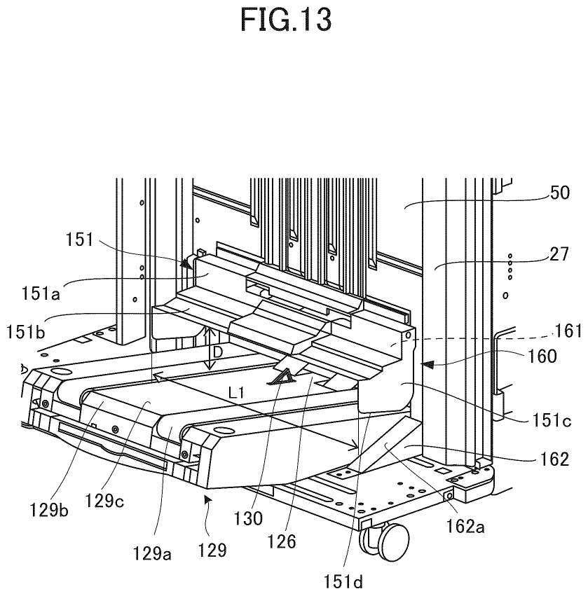

The saddle discharge tray 129 serving as a sheet bundle discharge portion (sheet bundle discharge unit) includes a downstream belt 129a, and on the saddle discharge tray 129, the sheet bundle conveyed from the saddle discharge upstream tray 127 is received and further guided and conveyed downstream by the downstream belt 129a. Specifically, the saddle discharge tray 129 includes the downstream belt 129a and a tray portion 129b as illustrated in FIGS. 12 and 13 that will be described later. A pair of downstream belts 129a are provided to be apart from each other in the width direction, and are capable of conveying the sheet bundle stacked on the tray portion 129b. A stacking surface 129c of the saddle discharge tray 129 for the sheet bundle is inclined upward in the vertical direction toward the downstream side in the conveyance direction. Therefore, the sheet bundle guided to the saddle discharge upstream tray 127 by the guide surface 124d is conveyed in a direction inclined downward in the vertical direction by the upstream belt 127a of the saddle discharge upstream tray 127, and is then conveyed in a direction inclined upward in the vertical direction by the downstream belt 129a of the saddle discharge tray 129.

In addition, the saddle discharge upstream sensor 128 that detects the sheet bundle on the upstream side is disposed on the upstream side in a conveyable region of the saddle discharge upstream tray 127, and the saddle discharge downstream sensor 130 that detects the sheet bundle on the downstream side is disposed on the upstream side in a conveyable region of the saddle discharge tray 129.

The sheet bundle passed on to the saddle discharge unit 131 is guided and conveyed by the saddle discharge upstream tray 127 and the saddle discharge tray 129, and is then stacked. The saddle discharge upstream tray 127 nips the sheet bundle at a nip point between the saddle discharge upstream tray 127 and the saddle discharge roller 125 described above on the downstream side in the conveyance direction. The sheet bundle present on the saddle discharge upstream tray 127 is configured to suppress opening on the opening portion side (fore edge side) at this nip point. The position of this nip point can change about a second fulcrum 124c in accordance with the thickness of the sheet bundle.

While the succeeding sheet bundle is processed, the preceding sheet bundle is conveyed upstream in the conveyance direction by the upstream belt 127a of the saddle discharge upstream tray 127, and is stopped after a predetermined conveyance amount since being detected by the saddle discharge upstream sensor 128 or the saddle discharge downstream sensor 130. The position where the preceding sheet bundle stops corresponds to a position where the opening on the opening portion side of the preceding sheet bundle can be suppressed at the nip point between the saddle discharge upstream belt 127 and the saddle discharge roller 125, and to a position where the succeeding sheet comes into contact with the upper surface of the preceding sheet bundle when being discharged. That is, in the present embodiment, the succeeding sheet bundle is stacked on the preceding sheet bundle such that the sheet bundles partially overlap each other in the saddle discharge unit 131.

As described above, the saddle discharge unit 131 discharges the succeeding sheet bundle onto the upper surface of the preceding sheet bundle without entering the opening portion of the preceding sheet bundle, and thus the sheet bundles are stably stacked on the stacking surface 129c of the saddle discharge tray 129 without occurrence of a failure such as getting caught by the preceding sheet bundle, getting curled against the preceding sheet bundle, or pushing out the preceding sheet bundle. That is, by appropriately changing the conveyance amount described above in accordance with the size of the sheet bundle, the succeeding sheet bundle can be stably stacked on the preceding sheet bundle.

The saddle discharge port 126 is disposed at a position downstream of the saddle discharge guide 124 in the first conveyance direction and between the saddle discharge upstream tray 127 and the saddle discharge tray 129. The sheet bundle conveyed to the saddle discharge unit 131 passes through the saddle discharge port 126 to be discharged to the outside of the sheet processing apparatus B, and thus the user can easily access the discharged sheet bundle.

To be noted, in the case where another apparatus is present on the downstream side of the saddle discharge unit 131, the sheet bundle can be passed on to the downstream apparatus by continuing the conveyance without the stacking. In addition, in the present embodiment, a discharge cover 151 serving as a cover member (cover unit) is provided on the outside of the saddle discharge guide 124. The discharge cover 151 is disposed so as not to interrupt discharge of the sheet bundle from the saddle discharge port 126 and such that an operator such as a user cannot access the inside of the apparatus through the saddle discharge port 126. In the present embodiment, as will be described in detail later, the discharge cover 151 is provided downstream of the square back processing unit 134 in the sheet bundle conveyance direction of the saddle third roller pair 118 such that when a child access probe according to the safety standard IEC 62368-1 is inserted from the outside of the apparatus, the child access probe does not reach the lower clamp unit 120 and the upper clamp unit 121.

### Control of Square Back Process

Next, the control of the square back process of the present embodiment will be described with reference to FIGS. 11A to 11D. As described above, the square back processing portion C2 performs the square back process of forming a corner on the spine of the sheet bundle subjected to the saddle binding process and the half-folding process. The half-folding controller 344 illustrated in FIG. 3 controls each conveyance roller pair of the folding roller pair 113, the saddle second roller pair 115, and the saddle third roller pair 118 by the same driving. Such a square back process will be described with reference to FIGS. 11A to 11D.

In the square back process, the half-folding controller 344 conveys the sheet bundle Sb subjected to the half-folding to the gap between the upper clamp unit 121 and the lower clamp unit 120 in the separated state in response to detection of the leading end of the sheet bundle Sb by the saddle conveyance sensor 117. Then, as illustrated in FIG. 11A, the half-folding controller 344 stops the conveyance of the sheet bundle Sb in a state in which a spine Ssp of the sheet bundle Sb protrudes further downstream in the first conveyance direction than the end surfaces 121b and 120c on the downstream side in the first conveyance direction of the upper clamp unit 121 and the lower clamp unit 120.

In this state, the square back process controller 345 drives the clamp driving motor 132 (FIGS. 7A and 7B) and thus moves the upper clamp unit 121 toward the lower clamp unit 120, and as illustrated in FIG. 11B, the sheet bundle Sb is nipped by the upper clamp unit 121 and the lower clamp unit 120. At this time, the spine Ssp of the sheet bundle Sb protrudes further downstream than the end surfaces 121b and 120c on the downstream side in the first conveyance direction of the upper clamp unit 121 and the lower clamp unit 120 by P1.

Next, the square back process controller 345 operates the driving motor 135 (FIG. 7B), and thus moves the square back processing unit 134 in the width direction of the sheet bundle Sb. At this time, as illustrated in FIG. 11C, the pressing roller 123 of the square back processing unit 134 moves in the width direction while pressurizing the spine Ssp of the sheet bundle Sb, and thus the square back process is performed on the spine Ssp of the sheet bundle Sb. Then, as illustrated in FIG. 11D, the square back process controller 345 drives the clamp driving motor 132 (FIGS. 7A and 7B), thus separates the upper clamp unit 121 from the lower clamp unit 120, and releases the nipping of the sheet bundle Sb. Then, the discharge operation of the sheet bundle Sb described above is performed.

### Details of Saddle Discharge Portion

Next, the saddle discharge portion 160 that discharges the sheet bundle processed by the saddle portion B2 of the sheet processing apparatus B of the present embodiment will be described by using FIGS. 12 to 21 with reference to FIG. 2. The saddle discharge portion 160 includes the saddle discharge unit 131 including the saddle discharge tray 129 described above and the like, the saddle discharge port 126, the discharge cover 151, and the like. The sheet bundle subjected to the saddle binding process and the half-folding process in the saddle portion B2 and the sheet bundle subjected to the square back process are discharged onto the saddle discharge tray 129 serving as a sheet bundle discharge portion through the saddle discharge port 126.

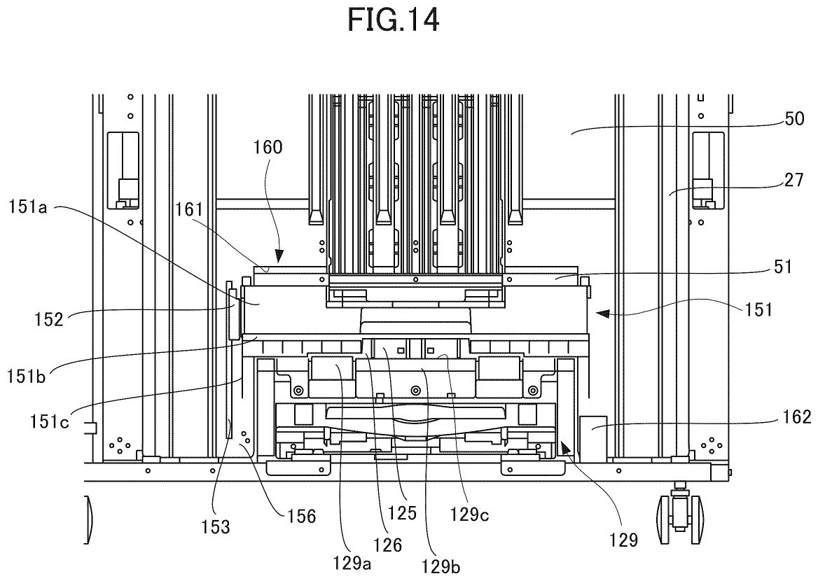

An opening portion 161 is provided on the sheet bundle discharge side of the saddle portion B2 of the housing 27 as illustrated in FIG. 12. That is, the housing 27 has an opening portion 161 at a position above the saddle discharge tray 129 on the stacking wall 50 that is a wall portion on the side on which the sheet bundle is discharged from the square back processing portion C2. In other words, the opening portion 161 is an opening formed at a lower portion of the stacking wall 50, and constitutes part of the saddle discharge port 126 described above. The saddle discharge port 126 is a gap formed between the discharge cover 151 and the saddle discharge tray 129 as a result of an upper portion of the opening portion 161 being covered by the discharge cover 151 as illustrated in FIGS. 13 and 14, and the sheet bundle is discharged through this gap and the opening portion 161. That is, the discharge cover 151 is disposed to cover part of the opening portion 161 such that the sheet bundle can be discharged from the inside of the housing 27 onto the saddle discharge tray 129 through the opening portion 161 and the gap between the discharge cover 151 and the saddle discharge tray 129.

Therefore, the opening area of the opening portion 161 is larger than the opening area of the saddle discharge port 126, and the inside of the apparatus can be accessed by opening the discharge cover 151 as will be described later. In addition, in the present embodiment, as illustrated in FIG. 2, the opening portion 161 is formed at a position to overlap with the saddle discharge guide 124 at least partially when viewed in the sheet bundle discharge direction.

Here, as described above, an opening of a sufficient size is required for a discharge port for discharging the sheet bundle subjected to the square back process. In the present embodiment, the sheet bundle is discharged through the saddle discharge port 126, and the opening portion 161 that is partially covered by the discharge cover 151 is provided. Therefore, the inside of the housing 27 can be accessed through the opening portion 161 when the discharge cover 151 is opened. A clamp mechanism C5 including the lower clamp unit 120 and the upper clamp unit 121 is provided in the housing 27. The clamp mechanism C5 pressurizes the sheet bundle by a force of, for example, 80 kgf (about 800 N), and therefore a configuration satisfying the safety standard IEC 62368-1 needs to be employed.

Therefore, in the present embodiment, the following configuration is employed. First, a saddle discharge guide 124 that guides the sheet bundle subjected to the square back process by the square back processing portion C2 toward the saddle discharge tray 129 is disposed at a position downstream of the square back processing portion C2 in the sheet bundle conveyance direction of the saddle third roller pair 118. In addition, the discharge cover 151 described above is provided at a position downstream of the saddle discharge guide 124 in the sheet bundle conveyance direction of the saddle third roller pair 118. As can be seen from FIGS. 12 and 13, a size L1 of the discharge cover 151 in the width direction of the sheet bundle is larger than a size L2 of the saddle discharge guide 124 in the width direction at a position at least partially overlapping with the saddle discharge guide 124 when viewed in the sheet bundle discharge direction. The discharge cover 151 is provided at a position with a gap of a distance D from the saddle discharge tray 129 in the vertical direction.

By employing such a configuration, the sheet bundle subjected to the square back process by the square back processing portion C2 is guided onto the saddle discharge tray 129 by the saddle discharge guide 124. Further, the sheet bundle is discharged through the saddle discharge port 126 that is the gap between the saddle discharge tray 129 and the discharge cover 151 having a larger size in the width direction than the saddle discharge guide 124. Therefore, it is difficult to access the clamp mechanism C5 of the square back processing portion C2 from the outside of the sheet processing apparatus B through the saddle discharge port 126. Particularly, even though the opening portion 161 is formed as in the present embodiment, the upper portion of the opening portion 161 is covered by the discharge cover 151 having a larger size in the width direction than the saddle discharge guide 124. The upper portion of the opening portion 161 is at a position close to the clamp mechanism C5, but in a state in which the upper portion is covered by the discharge cover 151 as described above, the clamp mechanism C5 cannot be accessed through the opening portion 161, and thus sufficient safety can be secured.

### Discharge Cover

The discharge cover 151 configured in this manner will be described in more detail. The discharge cover 151 is supported by a movable wall portion 51 capable of moving in the vertical direction along the stacking wall 50 together with the first tray 49. As described above, the first tray 49 is capable of moving up and down with respect to the processing tray 37, and gradually moves down as the sheet or sheet bundle is discharged onto the stacking surface 49a on which sheets are stacked. The trailing end of the sheet or sheet bundle stacked on the first tray 49 abuts the stacking wall 50 provided on the upstream side of the first tray 49 in the sheet discharge direction, and thus the sheet or sheet bundle is stacked along the stacking wall 50.

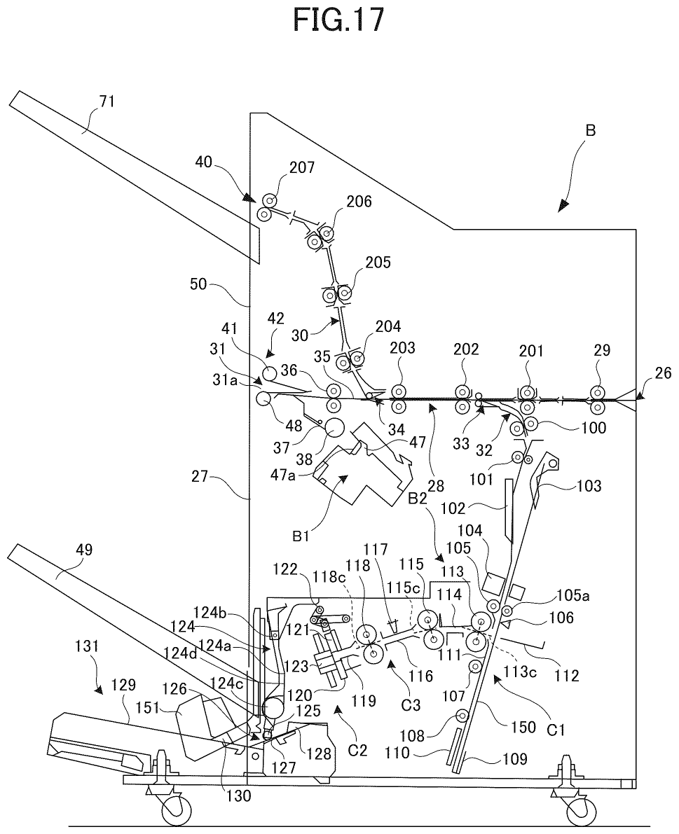

In the present embodiment, to increase the stacking amount of the sheet or sheet bundle on the first tray 49, the first tray 49 is configured to be capable of moving down to the position of FIG. 17 that will be described later. At this time, the stacking surface 49a of the first tray 49 is positioned below an upper end of the opening portion 161 in the vertical direction. In this case, the opening portion 161 is present upstream of the first tray 49 in the discharge direction, and therefore the trailing end of the sheet or sheet bundle on the first tray 49 cannot be regulated. Therefore, in the present embodiment, the movable wall portion 51 that moves together with the first tray 49 is provided as described above.

That is, the movable wall portion 51 moves together with the first tray 49 to cover a region of the opening portion 161 above the stacking surface 49a in the case where the first tray 49 moves down such that the stacking surface 49a is positioned below the upper end of the opening portion 161 in the vertical direction. As a result of this, even in the case where the first tray 49 moves down to a position where the stacking surface 49a is positioned below the upper end of the opening portion 161, the trailing end of the sheet or sheet bundle on the first tray 49 is regulated by the movable wall portion 51. As a result of this configuration, in the present embodiment, the stacking amount of the sheet or sheet bundle on the first tray 49 can be increased while reliably regulating the trailing end of the sheet or sheet bundle on the first tray 49.

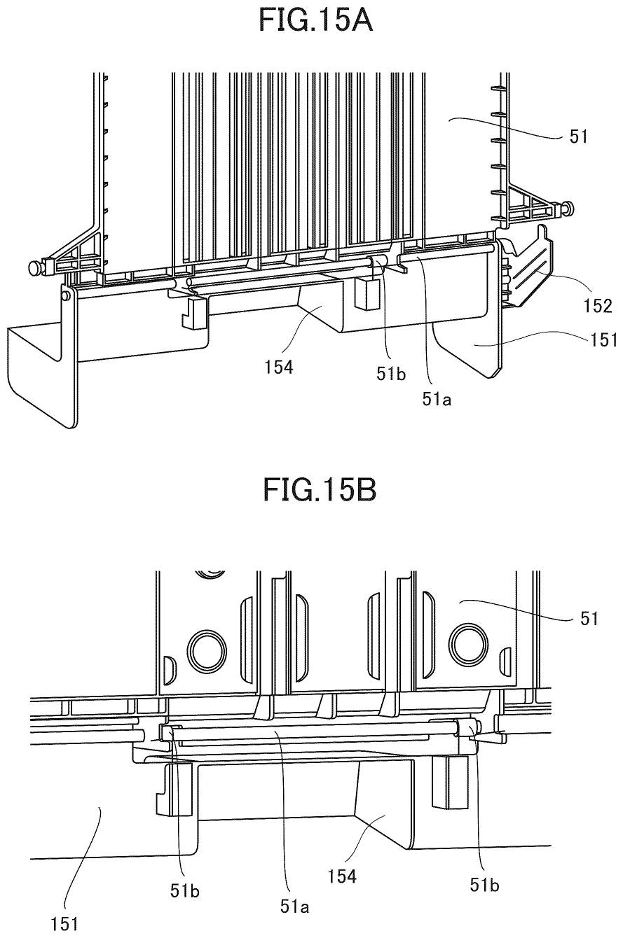

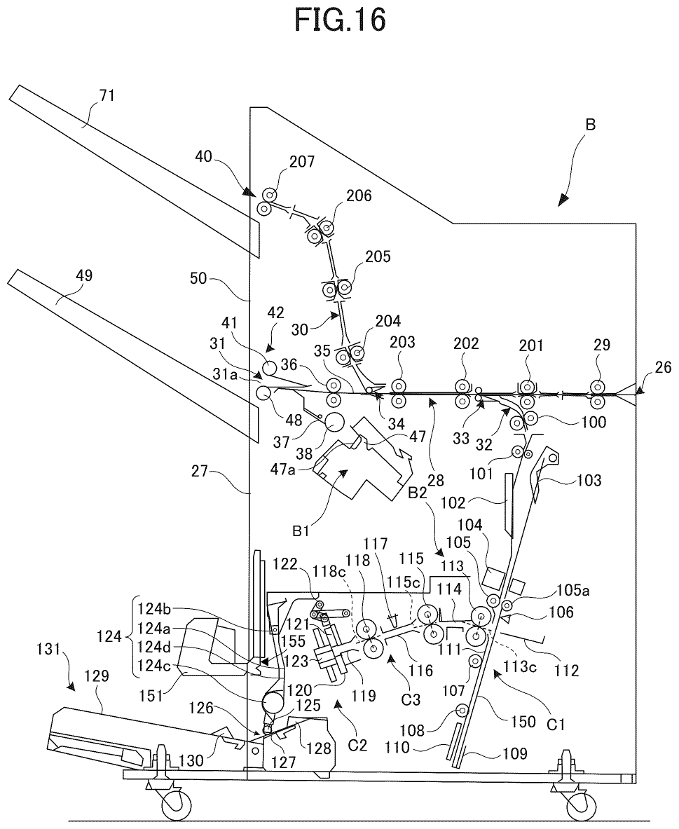

FIG. 15A is a perspective view of the discharge cover 151 and the movable wall portion 51 as viewed from the inside (back side), and FIG. 15B is an enlarged view of part thereof. As illustrated in FIGS. 15A and 15B, the discharge cover 151 is pivotably supported about a pivot shaft 51a provided parallel to the width direction on the movable wall portion 51. That is, the discharge cover 151 is capable of pivoting to a closed position (first position) illustrated in FIG. 2 and an open position (second position) illustrated in FIG. 16 about the pivot shaft 51a. The open position is a position where the opening portion 161 is exposed in the case where the first tray 49 is positioned above a predetermined position described later as illustrated in FIG. 16 in a state in which the lower end portion of the discharge cover 151 in the vertical direction is positioned more on the downstream side in the sheet bundle discharge direction than at the closed position.

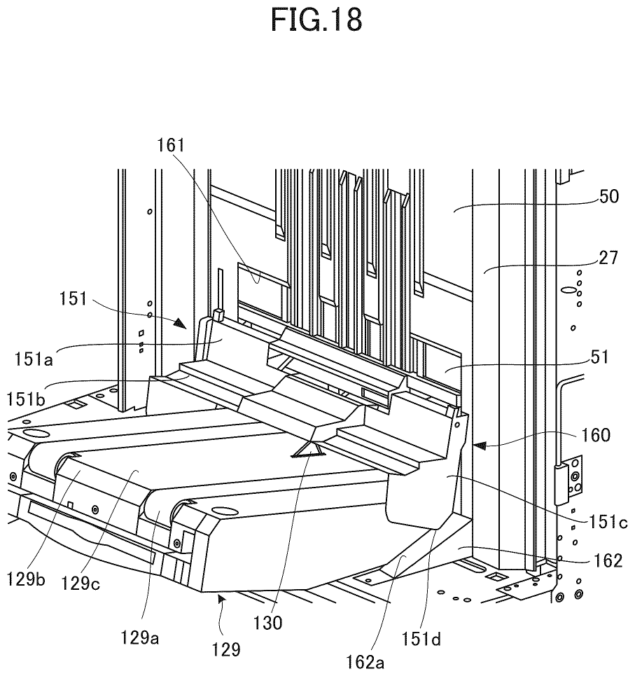

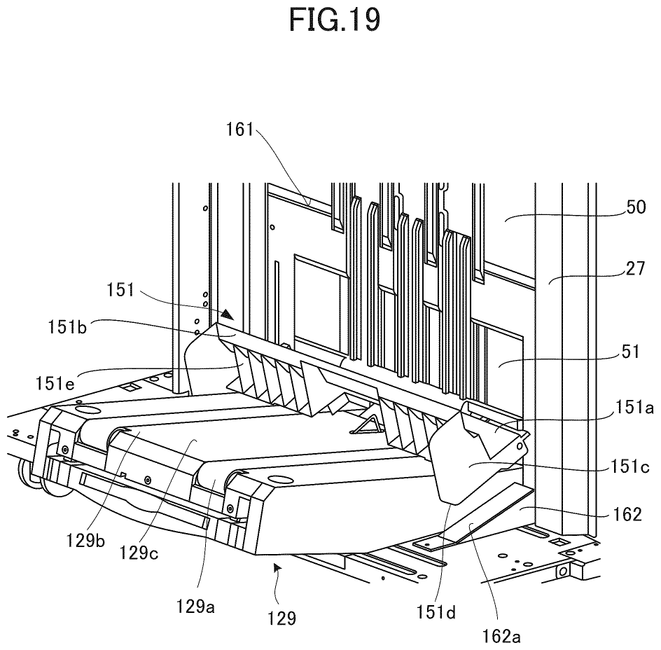

In the case where the first tray 49 moves down to a position below the predetermined position in the vertical direction together with the movable wall portion 51, the discharge cover 151 pivots about the pivot shaft 51a, and thus allows the first tray 49 to move down to the position below the predetermined position as illustrated in FIG. 17. To pivot the discharge cover 151 about the pivot shaft 51a, a guidance block 162 serving as a pivot guiding portion is disposed on one side of the saddle discharge tray 129 in the width direction as illustrated in FIGS. 18 and 19. The one side in the width direction on which the guidance block 162 is disposed may be either side among the two sides in the width direction, and is the right side of FIG. 14 in the present embodiment. In the case where the first tray 49 moves down to a position below the predetermined position, the guidance block 162 engages with part of the discharge cover 151, and guides the pivot of the discharge cover 151 about the pivot shaft 51a.

That is, as illustrated in FIGS. 13 and 14, the discharge cover 151 includes a first portion 151a provided to extend in approximately the vertical direction at the closed position to cover part of the opening portion 161, a second portion 151b provided to extend downstream in the sheet bundle discharge direction from a lower end portion of the first portion 151a in the vertical direction, and a pair of side surface portions 151c provided at two end portions of the first portion 151a and the second portion 151b in the width direction. The lower end portions of the pair of side surface portions 151c in the vertical direction are provided to extend below the second portion 151b in the vertical direction. Further, an abutting portion 151d provided at a lower end portion of the pair of side surface portions 151c is capable of engaging with the guidance block 162.

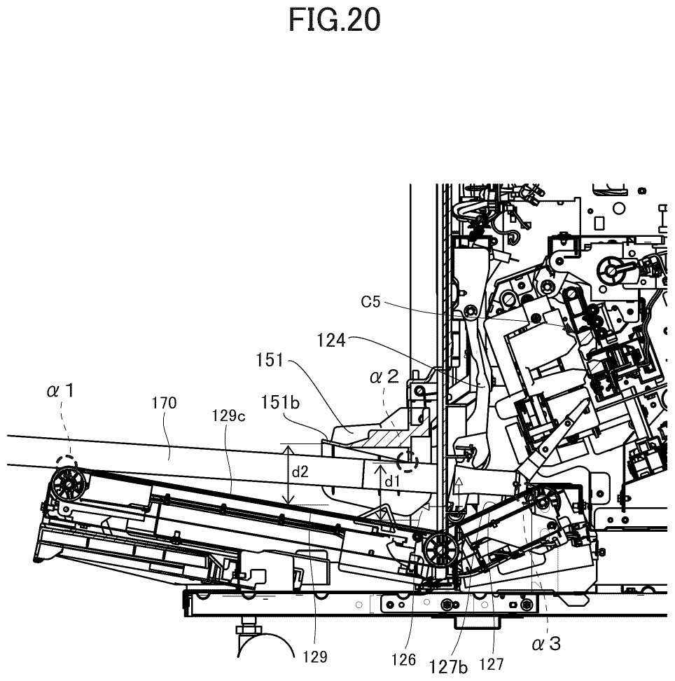

More specifically, the first portion 151a has a length larger than the length of the opening portion 161 in the width direction, and covers an upper portion of the opening portion 161 at the closed position. The second portion 151b has an equal length to the length of the first portion 151a in the width direction, and is provided to extend in the sheet bundle discharge direction from a lower end portion of the first portion 151a at the closed position. Further, the saddle discharge port 126 for discharging the sheet bundle is defined as a gap between the second portion 151b and the saddle discharge tray 129. The length of the second portion 151b in the sheet bundle discharge direction is set such that a “child access probe” does not reach the clamp mechanism C5 even when inserted in the saddle discharge port 126 (see FIG. 20 that will be described later).

The pair of side surface portions 151c are provided to cover two sides of the first portion 151a and the second portion 151b in the width direction and protrude to a position below the second portion 151b in the vertical direction. In addition, the distance between the pair of side surface portions 151c in the width direction is larger than the length of the saddle discharge tray 129 in the width direction. Therefore, the abutting portion 151d of the pair of side surface portions 151c can move to a position below the stacking surface 129c of the saddle discharge tray 129 without interfering with the saddle discharge tray 129 when the discharge cover 151 moves down together with the movable wall portion 51. In addition, the abutting portion 151d of the pair of side surface portions 151c is positioned downstream of the pivot shaft 51a pivotably supporting the discharge cover 151, in the sheet bundle discharge direction.

Meanwhile, the guidance block 162 has, on an upper surface thereof, a guiding surface 162a that guides the abutting portion 151d of the pair of side surface portions 151c that is part of the discharge cover 151. The guiding surface 162a is inclined downward toward the downstream side in the sheet bundle discharge direction. As a result of this, when the discharge cover 151 moves down together with the movable wall portion 51, as illustrated in FIG. 18, the abutting portion 151d of the pair of side surface portions 151c comes into contact with the guiding surface 162a of the guidance block 162. In the present embodiment, this position is set as a predetermined position.

Next, when the discharge cover 151 further moves down together with the movable wall portion 51, the abutting portion 151d of the pair of side surface portions 151c is guided along the inclination direction of the guiding surface 162a while engaging with the guiding surface 162a. Then, as the discharge cover 151 moves down, the abutting portion 151d moves downstream in the sheet bundle discharge direction, and as illustrated in FIG. 19, the discharge cover 151 pivots toward the open position about the pivot shaft 51a.

As illustrated in FIG. 19, guide ribs 151e are provided on the inner side (lower side at the closed position) of the second portion 151b. The guide ribs 151e are provided to oppose the stacking surface 129c of the saddle discharge tray 129 when the discharge cover 151 is at the closed position. Further, as a result of the guide ribs 151e being provided at an interval from the stacking surface 129c, a sheet bundle discharge path is defined between the guide ribs 151e and the stacking surface 129c. As described above, when the discharge cover 151 moves down together with the movable wall portion 51 to abut the guidance block 162 and thus pivot, in the case where the discharge cover 151 moves down and pivots to a certain position, the guide ribs 151e of the discharge cover 151 abut the stacking surface 129c of the saddle discharge tray 129. Then, as a result of the guide ribs 151e abutting the stacking surface 129c, the discharge cover 151 opens to a position of FIG. 19. At this position, the abutting portion 151d of the pair of side surface portions 151c and the guidance block 162 are not in contact with each other.

To be noted, as illustrated in FIGS. 18 and 19, in a state in which the movable wall portion 51 has moved down together with the first tray 49, control is performed such that a job of discharging a sheet bundle onto the saddle discharge tray 129 is not accepted. That is, in the case where the stacked sheet number of sheets of sheet bundle on the first tray 49 is large and the stacking surface 49a of the first tray 49 moves down to, for example, a position below the upper end of the opening portion 161, the reception of a job including a saddle binding process or a half-folding process in the saddle portion B2 is stopped. That is, in the case where the movable wall portion 51 has moved down to a position below the predetermined position in the vertical direction together with the first tray 49, the operation of the saddle portion B2 including the square back processing portion C2 is prohibited. Therefore, when the first tray 49 moves down to such a position, the sheet bundle is not discharged onto the saddle discharge tray 129.

In addition, the shapes of the guiding surface 162a of the guidance block 162 and the abutting portion 151d of the pair of side surface portions 151c may be any shape as long as the discharge cover 151 swings toward the open position when the discharge cover 151 moves down to abut the guidance block 162. For example, although the guiding surface 162a is formed as an inclined flat surface in the illustrated example, the guiding surface 162a may be a curved surface. In addition, in the illustrated example, the abutting portion 151d is constituted by a linear portion 151d1 approximately parallel to the sheet bundle discharge direction at the closed position and an inclined surface 151d2 inclined upward toward the upstream side from an upstream end portion of the linear portion 151d1 in the sheet bundle discharge direction. To be noted, the pair of side surface portions 151c may have a shape in which an upstream end portion of a lower end portion thereof in the sheet bundle discharge direction is curved, or a roller that rotates along the guiding surface 162a may be provided at the lower end portion of the pair of side surface portions 151c.

In addition, in the case of the present embodiment, as illustrated in FIGS. 15A and 15B, springs 51b serving as urging portions that urge the discharge cover 151 in a direction from the open position toward the closed position is provided. The springs 51b are, for example, torsion coil springs disposed around the pivot shaft 51a so as to be apart from each other in the width direction, and urge the discharge cover 151 toward the closed position. The urging portion may have a different configuration such as being formed from a rubber as long as the urging portion urges the discharge cover 151 toward the closed position.

In addition, in the case of the present embodiment, an interlocking portion 155 is provided as illustrated in FIG. 2. The interlocking portion 155 allows the operation of the saddle portion B2 including the square back processing portion C2 in the case where the discharge cover 151 is at the closed position, and prohibits the operation of the saddle portion B2 including the square back processing portion C2 in the case where the discharge cover 151 has pivoted by a predetermined amount from the closed position toward the open position. Therefore, as illustrated in FIG. 14, a flag 152 that pivots together with the discharge cover 151 is provided at an end portion of the discharge cover 151 on one side in the width direction. In addition, a slit 153 that the flag 152 can pass through when the discharge cover 151 moves together with the movable wall portion 51 is provided in a wall portion 156 around the opening portion 161 on the housing 27 side.

The interlocking portion 155 is, for example, a photo-interrupter disposed inside the housing 27. Therefore, the flag 152 provided on the discharge cover 151 can be detected by the interlocking portion 155 through the slit 153. The slit 153 is provided in a range where the discharge cover 151 moves in the vertical direction, and the flag 152 is capable of pivoting together with the discharge cover 151 while passing through the slit 153 within this range.

Then, when the flag 152 enters a gap between the light emitting portion and light receiving portion of the photo-interrupter, the interlocking portion 155 detects the flag 152, and when the flag 152 retracts from the gap between the light emitting portion and light receiving portion, the interlocking portion 155 no longer detects the flag 152. The interlocking portion 155 is configured to allow the operation of the saddle portion B2 including the square back processing portion C2 in a state in which the flag 152 is detected by the interlocking portion 155, and is configured to prohibit the operation of the saddle portion B2 in a state in which the flag 152 is not detected by the interlocking portion 155. That is, when the flag 152 is no longer detected by the interlocking portion 155, the saddle controller 350 stops the driving of the saddle portion B2. The predetermined amount described above is a pivot amount from a state in which the discharge cover 151 is at the closed position and the flag 152 is detected by the interlocking portion 155 to a time point when interlocking portion 155 stops detecting the flag 152 after the discharge cover 151 has pivoted toward the open position.

In addition, as illustrated in FIGS. 15A and 15B, a recess portion 154 recessed downstream in the sheet bundle discharge direction is provided in an approximate center portion of the back side of the discharge cover 151 in the width direction. As described above, the saddle discharge guide 124 is capable of swinging about the first fulcrum 124b serving as a swing shaft provided parallel to the width direction at an upper end portion in the vertical direction, and swings when guiding the sheet bundle subjected to the square back process by the square back processing portion C2 toward the saddle discharge tray 129 (see FIG. 2). Therefore, the discharge cover 151 has the recess portion 154 formed to recess downstream in the sheet bundle discharge direction so as not to interfere with the saddle discharge guide 124, in other words, so as to allow the swing of the discharge guide 124, when the saddle discharge guide 124 swings when guiding the sheet bundle.

In the case of the present embodiment configured in this manner, when the discharge cover 151 is at the open position, the operation of the saddle portion B2 is prohibited by the interlocking portion 155, and therefore, the operator can safely access the inside of the apparatus for work through the opening portion 161. In contrast, the apparatus is configured such that, in the case where the discharge cover 151 is at the closed position, since the operation of the saddle portion B2 is not prohibited, when access to the inside of the apparatus is attempted through the saddle discharge port 126, the hand or the like does not reach the clamp mechanism C5. As a result of this, the safety standard IEC 62368-1 can be satisfied by the present embodiment. This point will be described with reference to FIG. 20.

FIG. 20 is a section view of the sheet processing apparatus B of the present embodiment in a state in which a “child access probe (hereinafter referred to as an access probe 170)” has been inserted through the saddle discharge port 126. The access probe 170 is based on the safety standard IEC 62368-1. As described above, the saddle discharge port 126 is a gap between the discharge cover 151 and the saddle discharge tray 129. The discharge cover 151 has the second portion 151b protruding in the sheet bundle discharge direction, and the stacking surface 129c of the saddle discharge tray 129 is inclined downward toward the upstream side in the sheet bundle discharge direction. Therefore, the gap between the second portion 151b of the discharge cover 151 at the closed position and the stacking surface 129c of the saddle discharge tray 129 varies in the sheet bundle discharge direction. That is, a distance d1 at the position of the upstream end of the second portion 151b in the sheet bundle discharge direction is the smallest, and a distance d2 at the position of the downstream end of the second portion 151b in the sheet bundle discharge direction is the largest. For example, d1 is 60 mm, and d2 is 65 mm. As a result of the distances d1 and d2 are each set in this manner, the sheet bundle can be discharged onto the saddle discharge tray 129 without being interrupted by the discharge cover 151.

When the access probe 170 is inserted from the upstream side in the sheet bundle discharge direction through the saddle discharge port 126 configured in this manner, the access probe 170 comes into contact with three positions of a position α1 on a distal end portion (downstream end portion in the discharge direction) of the stacking surface 129c of the saddle discharge tray 129, a position α2 on the upstream end in the sheet bundle discharge direction of an inner surface of the second portion 151b, and a position α3 on the upstream side in the sheet bundle discharge direction of the stacking surface 127b of the saddle discharge upstream tray 127. Then, the access probe 170 cannot be inserted deeper (toward the upstream side in the sheet bundle discharge direction). As can be seen from FIG. 20, the access probe 170 does not reach the clamp mechanism C5, and it can be seen that the safety standard IEC 62368-1 is satisfied in the case of the configuration of the present embodiment.

### OTHER EMBODIMENTS

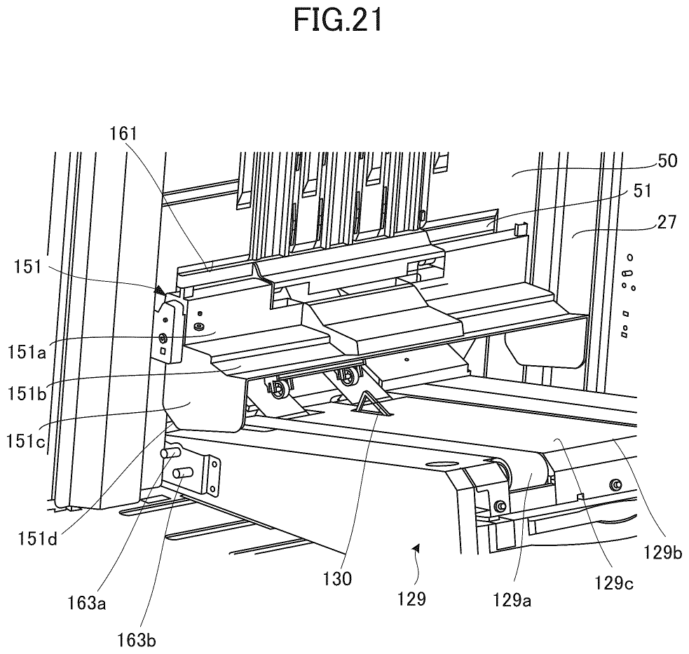

In the embodiment described above, the guidance block 162 is used as a pivot guiding portion that pivots the discharge cover 151 in the case where the first tray 49 moves down together with the movable wall portion 51. However, the configuration of the pivot guiding portion is not limited to this. For example, as illustrated in FIG. 21, two pins 163a and 163b each having a columnar shape may be provided on one side of the saddle discharge tray 129 in the width direction instead of the guidance block 162. The one side in the width direction on which the pins 163a and 163b are disposed may be either of the two sides in the width direction, and is the left side of FIG. 21 in the illustrated example. The pin 163b is provided at a position below the pin 163a in the vertical direction and downstream of the pin 163a in the sheet bundle discharge direction.

When the discharge cover 151 moves down, the abutting portion 151d of the pair of side surface portions 151c first engages with the upper pin 163a. Since the pin 163a is positioned downstream of the pivot shaft 51a of the discharge cover 151, when the discharge cover 151 continues to move down while the abutting portion 151d of the discharge cover 151 is in contact with the curved surface of the pin 163a, the abutting portion 151d is guided by the pin 163a, and therefore the discharge cover 151 pivots toward the open position.

Next, when the discharge cover 151 further moves down, the discharge cover 151 opens by a certain degree, and thus the abutting portion 151d engages with the lower pin 163b. Then, the abutting portion 151d is guided by the pin 163b, and thus the discharge cover 151 further pivots in the opening direction. Then, similarly to the case described with reference to FIG. 19, the discharge cover 151 moves down while the guide ribs 151e provided on the inner side of the discharge cover 151 are in contact with the stacking surface 129c, and thus the discharge cover 151 is opened. To be noted, the guidance block 162 described above or the pins 163a and 163b may be provided on only one side or on both sides in the width direction.

Although the square back process is performed on the downstream side in the saddle portion B2 in the sheet processing apparatus B in the embodiment described above, a similar square back process may be performed in a different body externally connected to the apparatus. For example, a single unit that performs only the square back process without performing the saddle binding process and the half-folding process may be provided. In this case, this unit includes the square back processing portion C2 described above, a conveyance portion such as a conveyance roller pair that conveys the sheet bundle subjected to the saddle binding process and the half-folding process to the square back processing portion C2, and the like.

In addition, although the sheet processing apparatus B includes a controller and controls each component in the sheet processing apparatus B in the present embodiment, each component in the sheet processing apparatus B may be a component controlled by a controller included in the image processing apparatus.

In addition, although the image forming system 1000 in which the sheet processing apparatus B is directly connected to the image forming apparatus A has been described in the embodiment described above, a different system configuration may be employed. For example, a different processing apparatus, a conveyance apparatus, or the like may be connected between the image forming apparatus A and the sheet processing apparatus B. In addition, although description has been given in the above-described embodiment by using the image forming apparatus A that forms a monochromatic image by using a toner as an example, an image forming apparatus that forms a color image by using toner may be used, or an image forming apparatus that forms an image on a sheet by using an ink may be used.

Further, although a roller pair has been described as an example of a conveyance portion that conveys a sheet in the sheet processing apparatus B in the embodiment described above, a configuration in which a sheet is conveyed by a belt may be employed. Specifically, any of a configuration in which a sheet is nipped and conveyed by a pair of belts, and a configuration in which a sheet is nipped by a belt and a roller may be employed, and the configuration for conveyance may be changed in accordance with the position and path at and through which the sheet is conveyed. For example, a configuration in which a sheet is conveyed by a pair of rollers at a certain position and the sheet is conveyed by a pair of belts at a different position may be employed.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-140510, filed on Aug. 30, 2023, which is hereby incorporated by reference herein in its entirety.

What is claimed is:

1. A sheet processing apparatus comprising:
an inlet portion configured to receive a sheet discharged from an image forming apparatus;
a first accumulation portion configured to accumulate the sheet received from the inlet portion;
a first binding processing unit configured to perform a binding process on an end portion of a sheet bundle constituted by a plurality of sheets accumulated in the first accumulation portion;
a stacking unit that is capable of moving up and down with respect to the first accumulation portion and on which the sheet bundle subjected to the binding process by the first binding processing unit is stacked;
a conveyance unit configured to convey the sheet downward in an up-down direction from a branching point in a conveyance path from the inlet portion to the first accumulation portion;
a second accumulation portion configured accumulate the sheet conveyed by the conveyance unit;
a second binding processing unit configured to perform a saddle binding process on a sheet bundle constituted by a plurality of sheets accumulated in the second accumulation portion;
a half-folding processing unit including a folding roller pair and a pressing portion and configured to perform a half-folding process on the sheet bundle subjected to the saddle binding process by the second binding process unit, the folding roller pair being configured to nip and convey the sheet bundle such that a spine of the sheet bundle is positioned downstream of a fore edge of the sheet bundle and thus perform half-folding on the sheet bundle, the pressing portion being configured to press the sheet bundle subjected to the saddle binding process by the second binding process unit toward a nip portion of the folding roller pair;
a conveyance roller pair configured to nip and convey the sheet bundle subjected to the half-folding process by the half-folding processing unit;
a square back processing unit including a pair of clamp portions configured to relatively move with respect to the sheet bundle conveyed by the conveyance roller pair to nip or not nip the sheet bundle, and a pressing roller provided downstream of the pair of clamp portions in a conveyance direction of the sheet bundle by the conveyance roller pair and press the spine of the sheet bundle nipped by the pair of clamp portions toward the pair of clamp portions, the square back processing unit being configured to perform a square back process of forming a corner on the spine of the sheet bundle by pressing, by the pressing roller, the spine of the sheet bundle nipped by the pair of clamp portions such that the spine of the sheet bundle protrudes downstream in the conveyance direction with respect to the pair of clamp portions;
a sheet bundle discharge unit to which the sheet bundle subjected to the square back process by the square back processing unit is discharged; and
a cover unit provided downstream of the square back processing unit in the conveyance direction such that a child access probe according to a safety standard IEC 62368-1 does not reach the pair of clamp portions in a case where the child access probe is inserted from an outside of the sheet processing apparatus.

2. The sheet processing apparatus according to claim 1, further comprising:
a discharge guide portion provided downstream of the square back processing unit in the conveyance direction and configured to guide the sheet bundle subjected to the square back process by the square back processing unit toward the sheet bundle discharge unit,
wherein the discharge guide portion is swingable about a swing shaft provided parallel to a sheet bundle width direction at an upstream end portion thereof in a vertical direction,
wherein the cover unit has a recess portion recessed downstream in a sheet bundle discharge direction so as to allow swing of the discharge guide portion in a case where the discharge guide portion swings to guide the sheet bundle subjected to the square back process by the square back processing unit toward the sheet bundle discharge unit.

3. The sheet processing apparatus according to claim 2, wherein the cover unit has a size in the sheet bundle width direction larger than a size in the sheet bundle width direction of the discharge guide portion at a position where the cover unit at least partially overlaps with the discharge guide portion in a case where the cover unit is viewed in the sheet bundle discharge direction, and the cover unit is provided at a distance from the sheet bundle discharge unit in the vertical direction.

4. The sheet processing apparatus according to claim 1, further comprising:
a discharge unit configured to discharge the sheet bundle subjected to the binding process by the first binding processing unit to the stacking unit; and
a wall portion that extends in a direction in which the stacking unit moves up and down and that an end portion of the sheet on an upstream side in a discharge direction of the discharge unit abuts,
wherein the wall portion has an opening portion at a position above the sheet bundle discharge unit, and
wherein the cover unit is provided to cover part of the opening portion.

5. The sheet processing apparatus according to claim 4, further comprising:
a movable wall portion movable along the wall portion in accordance with upward or downward movement of the stacking unit,
wherein the movable wall portion configured to move together with the stacking unit to cover a region of the opening portion higher than a stacking surface of the stacking unit on which sheets are stacked, in a case where the stacking unit has moved down such that the stacking surface is positioned below an upper end of the opening portion in a vertical direction.

6. The sheet processing apparatus according to claim 5,
wherein the cover unit is supported by the movable wall portion to be pivotable about a pivot shaft provided parallel to a sheet bundle width direction, and
wherein the sheet processing apparatus comprises a pivot guiding portion configured to engage with part of the cover unit and guide pivot of the cover unit about the pivot shaft in a case where the stacking unit moves down to a position below a predetermined position together with the movable wall portion.

7. The sheet processing apparatus according to claim 6,
wherein the cover unit is pivotable about the pivot shaft to a first position and a second position where a lower end portion thereof in the vertical direction is at a more downstream position in a sheet bundle discharge direction than at the first position, and
wherein the sheet processing apparatus further comprises:
an urging portion configured to urge the cover unit from the second position toward the first position; and
an interlocking portion configured to allow an operation of the square back processing unit in a case where the cover unit is at the first position and prohibit the operation of the square back processing unit in a case where the cover unit has pivoted by a predetermined amount from the first position toward the second position.

8. The sheet processing apparatus according to claim 6, wherein an operation of the square back processing unit is prohibited in a case where the movable wall portion has moved down to a position below the predetermined position in the vertical direction together with the stacking unit.

9. The sheet processing apparatus according to claim 1,
wherein in a case where a straight line that passes through a nip of the folding roller pair in a state in which the folding roller pair is not nipping the sheet bundle and that is orthogonal to a sheet bundle width direction and a first line passing through rotational centers of the folding roller pair is a first virtual line and a straight line that passes through a nip of the conveyance roller pair in a state in which the conveyance roller pair is not nipping the sheet bundle and that is orthogonal to the sheet bundle width direction and a second line passing through rotational centers of the conveyance roller pair is a second virtual line,
the conveyance roller pair is provided such that the second virtual line intersects with the first virtual line and the second virtual line is inclined downward in a vertical direction toward a downstream side in a conveyance direction of the folding roller pair, and
a conveyance path in which the sheet bundle is conveyed between the folding roller pair and the conveyance roller pair is bent such that the sheet bundle conveyed by the folding roller pair is passed on to the conveyance roller pair.

10. An image forming system comprising:
an image forming unit including an image forming portion configured to form an image on a sheet; and
the sheet processing apparatus according to claim 1,
wherein the sheet processing apparatus performs the square back process on a sheet bundle constituted by sheets on which images has been formed by the image forming portion.
